(19) United States
(12) Patent Application Publication
(10) Pub. No.: US 2016/0187955 A1
(43) Pub. Date: Jun. 30, 2016

(54) INFORMATION PROCESSING APPARATUS, INFORMATION PROCESSING METHOD AND COMPUTER PROGRAM PRODUCT

(71) Applicant: Hisanori KAWAURA, Kanagawa (JP)

(72) Inventor: Hisanori KAWAURA, Kanagawa (JP)

(73) Assignee: Ricoh Company, Limited, Tokyo (JP)

(21) Appl. No.: 14/975,958

(22) Filed: Dec. 21, 2015

(30) Foreign Application Priority Data
Dec. 25, 2014 (JP) 2014-263361
Nov. 4, 2015 (JP) 2015-216807

(51) Int. Cl. G06F 1/32

(52) U.S. Cl. CPC G06F 1/3209; G06F 1/3287

(57) ABSTRACT

An information processing apparatus includes: a WOL setting unit that sets WOL setting set information indicating whether a WOL being a function by which power supply to an information processing unit is started when being triggered by receipt of a specific packet from a server, is set or not; a state controlling unit that when receiving a shutdown start request and if the WOL setting set information indicates that the WOL is set, exercises control so as to transition into a WOL standby state; a WOL setting controlling unit that exercises control so as to set the WOL before transition into the WOL standby state; and a WOL setting storage controlling unit that, upon transition into the WOL standby state, exercises control so as to store WOL setting enabling information indicating that the WOL has been set, into a non-volatile memory.

### CROSS-REFERENCE TO RELATED APPLICATIONS

The present application claims priority to and incorporates by reference the entire contents of Japanese Patent Application No. 2014-263361 filed in Japan on Dec. 25, 2014 and Japanese Patent Application No. 2015-216807 filed in Japan on Nov. 4, 2015.

### BACKGROUND OF THE INVENTION

1. Field of the Invention

The present invention relates to an information processing apparatus, an information processing method and a computer program product.

2. Description of the Related Art

Conventionally, an information processing apparatus such as a Personal Computer (PC) having a function called Wake on Local Area Network (LAN) (hereinafter, “WOL”) that turns on a power source of the information processing apparatus by remote control from a server is manufactured as a commercial product.

For example, Japanese Laid-open Patent Publication No. 11-353266 discloses a method for managing the connection state among an external power source, an expansion unit, and a notebook PC, in order to realize a remote managing function according to WOL by using a LAN controller of the expansion unit, only in a state where the external power source is connected to the expansion unit provided with the LAN controller capable of setting WOL while, also, the expansion unit is connected to the notebook PC.

According to the technique disclosed in Japanese Laid-open Patent Publication No. 11-353266, however, when the external power source is cut off, for example, because of a power outage or because the plug comes out of a power outlet, the WOL setting is erased (cleared) at the same time as the power source is cut off. Thus, a problem arises where it is not possible to turn on the power source by using WOL even after the external power source is recovered.

### SUMMARY OF THE INVENTION

It is an object of the present invention to at least partially solve the problems in the conventional technology.

An information processing apparatus includes: an information processing unit that performs information processing; a power controlling unit that is connected to an external power source and exercises power control; a Wake_on_LAN (WOL) setting unit that sets WOL setting set information indicating whether a WOL is set or not, the WOL being a function by which power supply to at least the information processing unit is started when being triggered by receipt of a specific packet from a server; a state controlling unit that when receiving a shutdown start request requesting that the power supply to at least the information processing unit be stopped while power supply to at least the power controlling unit be continued and if the WOL setting set information indicates that the WOL is set, exercises control so as to transition into a WOL standby state in which the power supply to at least the information processing unit is stopped, while power supply to a receiving unit that receives the specific packet and to the power controlling unit is continued; a WOL setting controlling unit that exercises control so as to set the WOL before transition into the WOL standby state; and a WOL setting storage controlling unit that, upon transition into the WOL standby state, exercises control so as to store WOL setting enabling information indicating that the WOL has been set, into a non-volatile memory.

An information processing method is implemented by an information processing apparatus including at least an information processing unit that performs information processing and a power controlling unit that is connected to an external power source and exercises power control. The information processing method includes: setting WOL setting set information indicating whether a WOL is set or not, the WOL being a function by which power supply to at least the information processing unit is started when being triggered by receipt of a specific packet from a server; when receiving a shutdown start request requesting that the power supply to at least the information processing unit be stopped while power supply to at least the power controlling unit be continued and if the WOL setting set information indicates that the WOL is set, exercising control so as to transition into a WOL standby state in which the power supply to at least the information processing unit is stopped, while power supply to a receiving unit that receives the specific packet and to the power controlling unit is continued; exercising control so as to set the WOL before transition into the WOL standby state; and upon transition into the WOL standby state, exercising control so as to store WOL setting enabling information indicating that a setting of the WOL is enabled, into a non-volatile memory included in the power controlling unit.

A computer program product includes a non-transitory computer-readable medium containing an information processing program for a computer of an information processing apparatus including at least an information processing unit that performs information processing and a power controlling unit that is connected to an external power source and exercises power control. The program causes the computer to perform: setting WOL setting set information indicating whether a WOL is set or not, the WOL being a function by which power supply to at least the information processing unit is started when being triggered by receipt of a specific packet from a server; when receiving a shutdown start request requesting that the power supply to at least the information processing unit be stopped while power supply to at least the power controlling unit be continued and if the WOL setting set information indicates that the WOL is set, exercising control so as to transition into a WOL standby state in which the power supply to at least the information processing unit is stopped, while power supply to a receiving unit that receives the specific packet and to the power controlling unit is continued; exercising control so as to set the WOL before transition into the WOL standby state; and upon transition into the WOL standby state, exercising control so as to store WOL setting enabling information indicating that a setting of the WOL is enabled, into a non-volatile memory included in the power controlling unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram of an exemplary hardware configuration of a multifunction peripheral according to a first embodiment;

FIG. 2 is a diagram of an exemplary hardware configuration of a low-power device microcomputer;

FIG. 3 is a diagram of an exemplary software configuration of the multifunction peripheral;

FIG. 4 is a diagram of an exemplary functional configuration of the multifunction peripheral;

FIG. 5 is a flowchart of an exemplary operation performed by the multifunction peripheral when determining whether WOL should be set or not;

FIG. 6 is a flowchart of an exemplary operation performed by the multifunction peripheral when shutting down;

FIG. 7 is a diagram illustrating an example of a power state of the multifunction peripheral;

FIG. 8 is a diagram illustrating another example of a power state of the multifunction peripheral;

FIG. 9 is a flowchart of an exemplary operation performed by the low-power device microcomputer after a shutdown;

FIG. 10 is a flowchart of an exemplary operation performed by the low-power device microcomputer when power supply from an external power source to the low-power device microcomputer is started;

FIG. 11 is a flowchart of an example of a process performed by a multifunction peripheral start-up unit;

FIG. 12 is a diagram illustrating an example of a power state of the multifunction peripheral;

FIG. 13 is a drawing of an example of a setting file;

FIG. 14 is a drawing of an example of a display indicating that WOL is currently set;

FIG. 15 is a drawing of an example of a display indicating that the multifunction peripheral is to instantly shut down because an unexpected start-up has occurred;

FIG. 16 is a diagram of an exemplary hardware configuration of a multifunction peripheral according to a second embodiment;

FIG. 17 is a flowchart of an exemplary operation performed by the low-power device microcomputer when the power supply from the external power source to the low-power device microcomputer is started;

FIG. 18 is a diagram illustrating an example of a power state of the multifunction peripheral;

FIG. 19 is a diagram of an exemplary hardware configuration of a multifunction peripheral according to a third embodiment;

FIG. 20 is a flowchart of an exemplary operation performed by the low-power device microcomputer when the power supply from the external power source to the low-power device microcomputer is started;

FIG. 21 is a diagram illustrating an example of a power state of the multifunction peripheral;

FIG. 22 is a diagram of examples of functions of a multifunction peripheral according to a fourth embodiment;

FIG. 23 is a flowchart of an example of a process performed by a multifunction peripheral start-up unit according to the fourth embodiment;

FIG. 24 is a drawing of an example of a setting file according to the fourth embodiment;

FIG. 25 is a drawing of an example of a display indicating an abnormal stop;

FIG. 26 is a diagram of examples of functions of a multifunction peripheral according to a fifth embodiment;

FIG. 27 is a flowchart of an exemplary operation performed by the multifunction peripheral when establishing various types of settings in response to operations by a user;

FIG. 28 is a flowchart of an exemplary operation performed by the multifunction peripheral when shutting down; and

FIG. 29 is a flowchart of an exemplary operation performed by the low-power device microcomputer after a shutdown.

### DETAILED DESCRIPTION OF THE PREFERRED EMBODIMENTS

Exemplary embodiments of an information processing apparatus, an information processing method and a computer program product according to the present invention will be explained in detail below, with reference to the accompanying drawings. Hereinafter, a multifunction peripheral (MFP), which is an image processing apparatus in one form, will be explained as an example of the information processing apparatus according to the present invention; however, possible embodiments are not limited to this example. The multifunction peripheral is an apparatus having a plurality of mutually-different functions such as a copying function, a scanner function, a printing function, a fax function, and/or the like.

### First Embodiment

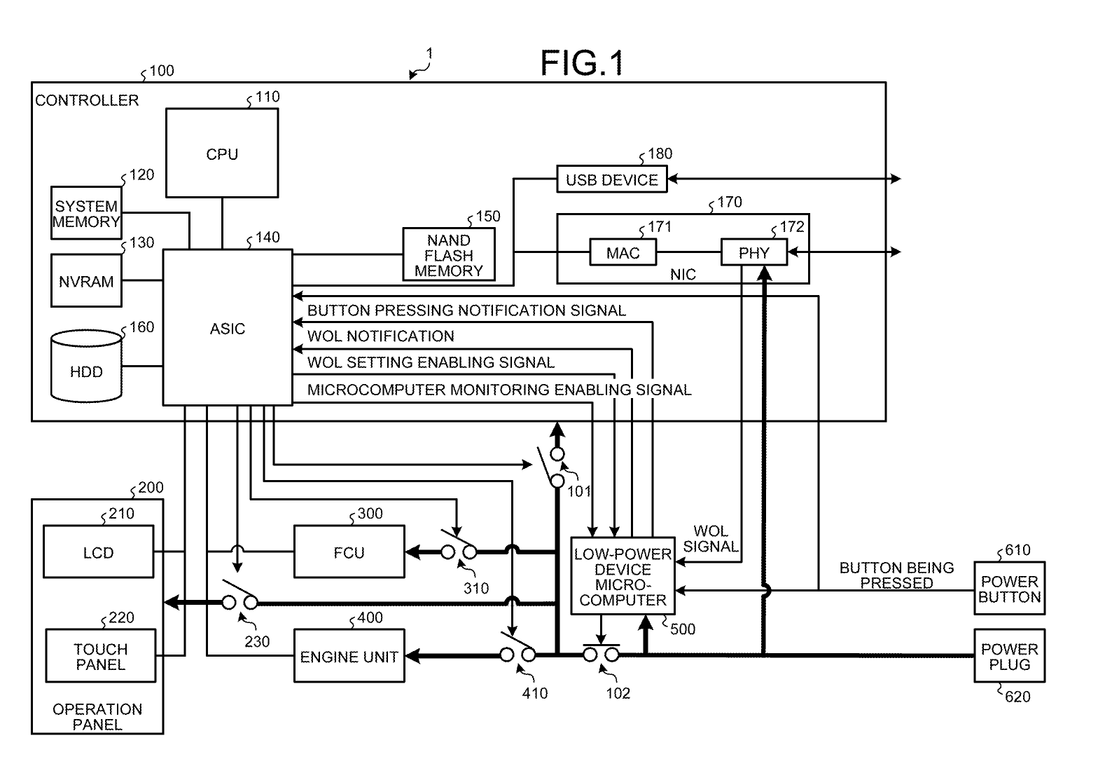

FIG. 1 is a diagram of an exemplary hardware configuration of a multifunction peripheral 1 according to the present embodiment. As illustrated in FIG. 1, the multifunction peripheral 1 includes a controller 100 that performs various types of information processing, an operation panel 200, a fax control unit (hereinafter, “FCU”) 300, an engine unit 400 that provides an image forming function, a low-power device microcomputer 500, a power button 610, and a power plug 620. In the present example, the power plug 620 is connected to the low-power device microcomputer 500. The power plug 620 is a connection part that connects together the multifunction peripheral 1 and a power outlet connected to an external power source (typically, a commercial power source) and is used for supplying electric power. More specifically, when the power plug 620 is connected to the power outlet having a socket (a socket for the power plug 620), the electric power from the external power source is supplied to the low-power device microcomputer 500. In the present example, the low-power device microcomputer 500 is connected to the external power source and exercises power control. Specifics of the low-power device microcomputer 500 will be explained later. Further, in the present example, it is considered that the low-power device microcomputer 500 corresponds to the “power controlling unit” in the claims, whereas the controller 100 corresponds to the “information processing unit” in the claims.

The controller 100 includes a Central Processing Unit (CPU) 110, a system memory 120, a Non-Volatile Random Access Memory (NVRAM) 130, an Application-Specific Integrated Circuit (ASIC) 140, a NAND flash memory 150, a Hard Disk Drive (HDD) 160, a Network Interface Card (NIC) 170, and a Universal Serial Bus (USB) device 180.

The operation panel 200 includes a touch panel 220 that receives an input operation from an operator and a Liquid Crystal Display (LCD) 210 that realizes a display for the operator (by displaying various types of information including information processing results obtained by the controller 100). In the present example, it is considered that the LCD 210 (or the operation panel 200) corresponds to the “display unit” in the claims. The touch panel 220 and the LCD 210 are each connected to the ASIC 140 included in the controller 100.

Further, in the present embodiment, the NIC 170, the USB device 180, the FCU 300, and the engine unit 400 are connected to the ASIC 140 included in the controller 100 via a Peripheral Component Interconnect (PCI) bus. To the ASIC 140, the system memory 120, the NVRAM 130, the NAND flash memory 150, and the HDD 160 are connected. Further, the CPU 110 and the ASIC 140 are connected to each other via a system bus.

The CPU 110 exercises overall control of the multifunction peripheral 1. The CPU 110 starts up and executes an Operating System (OS), image forming applications, and the like. The system memory 120 is a memory that is used as an image rendering memory for the multifunction peripheral 1 and as a memory for operating applications. The NVRAM 130 is a non-volatile semiconductor memory that is rewritable and is capable of holding internal data therein even if the power supply is cut off (even if the power source is turned off). The NVRAM 130 is able to store therein, for example, data related to a system setting of the multifunction peripheral 1 and a setting related to networks.

The ASIC 140 is an Integrated Circuit (IC) for image processing purposes and includes image-processing-purpose hardware elements. The ASIC 140 is further provided with general-purpose input/output ports. The general-purpose ports include: a plurality of ports (terminals each of which is connected to a signal line through which a corresponding signal is supplied) corresponding to signals serving as triggers to start a state change of the multifunction peripheral 1 (e.g., a signal that changes when the power button 610 is pressed, and signals issued by the low-power device microcomputer 500 to indicate that the button is pressed and to indicate a WOL signal explained later is issued); a plurality of ports corresponding to signals for controlling whether or not power should be supplied to (whether the power source should be turned on or off for) functional units of the multifunction peripheral 1 (e.g., a signal that controls an operation-panel controlling switch (SW) 230 that switches between power being supplied and not being supplied to the operation panel 200, a signal that controls an FCU controlling SW 310 that switches between power being supplied and not being supplied to the FCU 300, a signal that controls an engine controlling SW 410 that switches between power being supplied and not being supplied to the engine unit 400, and a signal that controls a controller controlling SW 101 that switches between power being supplied and not being supplied to the controller 100); and a plurality of ports corresponding to signals that transfer power source monitoring to the low-power device microcomputer 500 (e.g., a microcomputer monitoring enabling signal explained later, a WOL setting enabling signal explained later).

The HDD 160 is an example of a storage (an auxiliary storage device) that stores therein image data, document data, computer programs, font data, forms, and/or the like. The NAND flash memory 150 is a non-volatile memory for storing therein the OS and the applications. The NIC 170 is an interface device that connects the multifunction peripheral 1 to a network and includes a Media Access Control (MAC) unit 171 and a physical layer (PHY) 172. The MAC unit 171 includes a communication-purpose buffer and is configured to control transmissions and receptions to and from the network. The PHY 172 is configured to physically convert a data transfer in accordance with an external interface. Further, the PHY 172 is also capable of issuing a Wake_on_LAN signal (hereinafter, a “WOL signal”) used for starting the power supply to at least the controller 100, in response to receipt of a magic packet (corresponding to the “specific packet” in the claims) that triggers the power source of the multifunction peripheral 1 to be turned on. The magic packet that triggers the power source of the multifunction peripheral 1 to be turned on contains at least a MAC address indicating a physical address uniquely assigned to the multifunction peripheral 1. In the present example, it is considered that the PHY 172 corresponds to the “receiving unit” in the claims.

The USB device 180 is an interface device that connects a peripheral device compliant with a USB standard to the multifunction peripheral 1. The low-power device microcomputer 500 is connected to the external power source (the power plug 620) and is configured to exercise power control over the multifunction peripheral 1. In the present embodiment, the low-power device microcomputer 500 is configured to monitor whether the power button 610 has been pressed and monitor a WOL signal and to issue a button pressing notification signal to notify the ASIC 140 that the power button 610 has been pressed and a WOL notification signal to notify the ASIC 140 that a WOL signal is issued. Further, the low-power device microcomputer 500 is also configured to check to see whether a WOL setting enabling signal is issued or not, the WOL setting enabling signal indicating that WOL has been set, WOL being a function by which the power supply to at least the controller 100 is started when being triggered by receipt of a specific packet (the magic packet) from a server. Details of this configuration will further be explained later.

The power button 610 is used as a trigger for supplying the power to the multifunction peripheral 1 from the external power source (the power plug 620). The engine unit 400 includes a scanner that reads an image and a plotter that performs a printing process. The FCU 300 includes a memory. The memory included in the FCU 300 is used for, for example, temporarily storing therein facsimile data received while the power source of multifunction peripheral 1 is turned off.

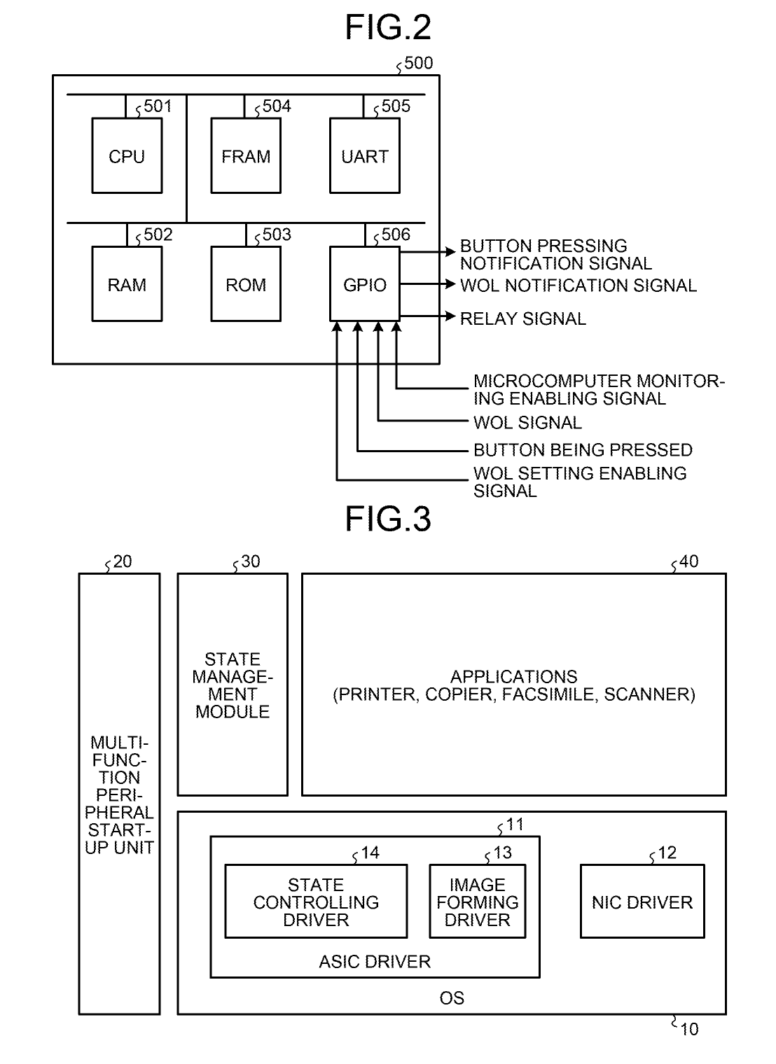

FIG. 2 is a diagram of an exemplary hardware configuration of the low-power device microcomputer 500. As illustrated in FIG. 2, the low-power device microcomputer 500 includes a CPU 501, a Random Access Memory (RAM) 502, a Read-Only Memory (ROM) 503, a Ferroelectric Random Access Memory (FRAM) 504, a Universal Asynchronous Receiver/Transmitter (UART) 505, and a General-Purpose Input/Output (GPIO) 506.

The CPU 501 is configured to comprehensively control the low-power device microcomputer 500. The CPU 501 is configured to start up and execute a power-source controlling firmware that provides a power-source controlling function. The RAM 502 is a temporary memory used for operating the power-source controlling firmware. The ROM 503 is a non-volatile memory for storing therein the power-source controlling firmware. The FRAM 504 is a non-volatile semiconductor memory that is rewritable and is capable of holding internal data therein even if the power source is turned off. The FRAM 504 is configured to store therein, for example, various types of settings of the power-source controlling firmware. The UART 505 is a debugging-purpose interface used for a console display or the like.

The GPIO 506 is represented by general-purpose input/output ports. Specific power-source control is executed by controlling the ports thereof. The power-source controlling firmware is configured to monitor a signal that changes as a result of pressing of the power button (to monitor the port corresponding to the signal), to monitor the WOL signal set by the PHY 172, to control a port corresponding to the button pressing notification signal to notify the ASIC 140 that the power button 610 has been pressed (e.g., to exercise control so as to set the voltage of the corresponding port to a predetermined level, when the button pressing notification signal is issued), and to control a port corresponding to the WOL notification signal to notify the ASIC 140 that a WOL signal is issued (e.g., to exercise control so as to set the voltage of the corresponding port to a predetermined level, when the WOL notification signal is issued). Further, the power-source controlling firmware is configured to control a port corresponding to a signal (in the present example, a relay signal for controlling a relay SW 102 that turns on the operation-panel controlling SW 230, the FCU controlling SW 310, the engine controlling SW 410, and the controller controlling SW 101, in conjunction with one another) that controls whether or not power is to be supplied to functional units of the multifunction peripheral 1 (e.g., to exercise control so as to set the voltage of the corresponding port to a predetermined level, when the relay signal is issued). Further, the power-source controlling firmware is also configured to monitor the microcomputer monitoring enabling signal explained later and the WOL setting enabling signal explained later.

FIG. 3 is a diagram of an exemplary software configuration of the multifunction peripheral 1. As illustrated in FIG. 3, the multifunction peripheral 1 includes an OS 10, a multifunction peripheral start-up unit 20, a state management module 30, and applications 40.

The OS 10 is UNIX (registered trademark) or the like and is configured to execute, in parallel to one another, pieces of software in the applications 40 as processes. The OS 10 includes a memory management function that manages used regions of the RAM, a process/thread management function that manages schedules regarding which CPU executes each process/thread with what timing, a process/thread priority level management function that changes priority levels depending on the CPU usage rate of each process/thread, as well as a file system that provides a file input/output for accesses to the NAND flash memory 150 and to the HDD 160, and device drivers for controlling the multifunction peripheral 1.

The device drivers provided by the OS 10 include a NAND flash memory driver, an HDD driver, an NVRAM driver, an FCU communication driver, an LCD driver, an engine communication driver, a USB driver, a touch panel driver, an ASIC driver, and an NIC driver that are used for controlling the hardware illustrated in FIG. 1. In this configuration, because the drivers other than an ASIC driver 11 and an NIC driver 12 have no special characteristics, explanation thereof will be omitted. The ASIC driver 11 includes an image forming driver 13 provided with an interface for using an image processing function of the ASIC 140 and a state controlling driver 14 that controls the general-purpose input/output ports of the ASIC 140. The NIC driver 12 has functions of not only transmitting and receiving packets on a network, but also detecting the reception of the magic packet while the power source is turned off (while in a WOL standby state, which is explained later).

The multifunction peripheral start-up unit 20 is the process that is started up first after the OS 10 is started up and is thereafter configured to control start-up methods of the state management module 30 and the applications 40, and the order in which they are started up, on the basis of a setting file stored in the NAND flash memory 150. The state management module 30 is configured to control the state and to change the state of the multifunction peripheral 1 on the basis of events that occur.

The applications 40 are configured to perform unique processes corresponding to user services related to image forming processes performed by the printer, the copier, the facsimile, the scanner, and/or the like. The applications 40 include a printer application that is a printer-specific application having a Page Description Language (PDL) (or a Printer Control Language [PCL]) and a PostScript (PS), a copier application that is a copier-specific application, a fax application that is a facsimile-specific application, and a scanner application that is a scanner-specific application.

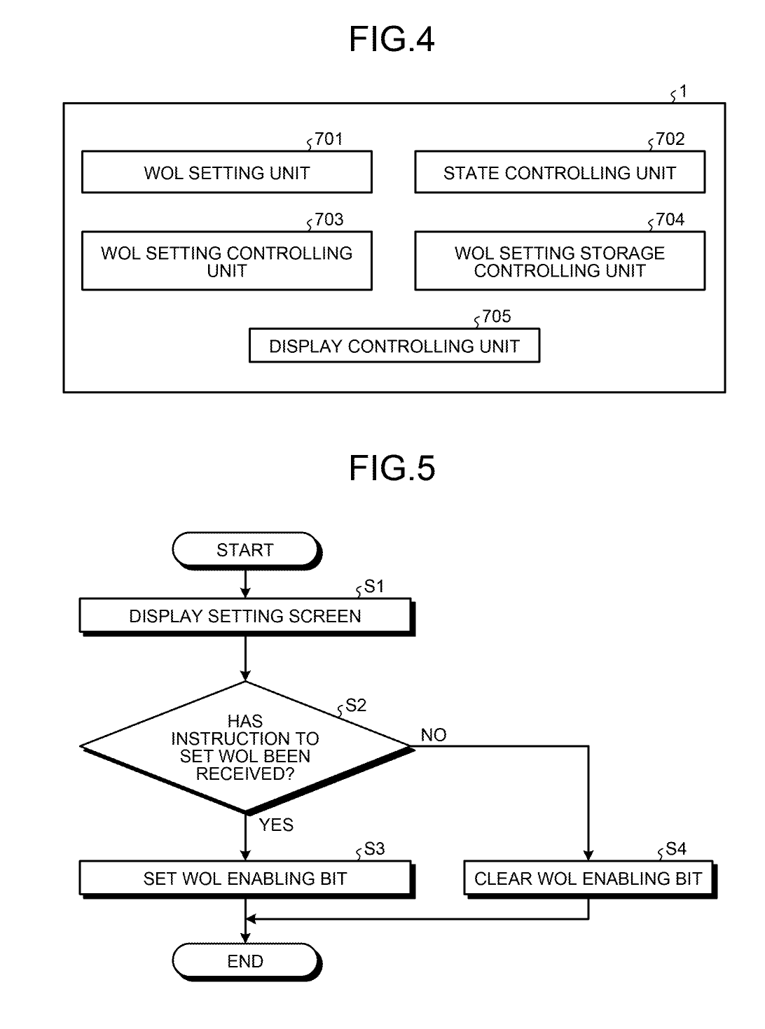

FIG. 4 is a diagram of an exemplary functional configuration of the multifunction peripheral 1. As illustrated in FIG. 4, the multifunction peripheral 1 includes a WOL setting unit 701, a state controlling unit 702, a WOL setting controlling unit 703, a WOL setting storage controlling unit 704, and a display controlling unit 705. Although FIG. 4 primarily illustrates the functions related to the present embodiment for the sake of convenience in the explanation, possible functions of the multifunction peripheral 1 are not limited to these functions.

The WOL setting unit 701 is configured to set WOL setting set information indicating whether WOL is set or not. In the present example, when having received an instruction from the user indicating that WOL should be set, the WOL setting unit 701 sets a WOL enabling bit (an example of the WOL setting set information) indicating that WOL is set, into the NVRAM 130.

Upon receiving a shutdown start request requesting that the power supply to at least the controller 100 be stopped while the power supply to at least the low-power device microcomputer 500 be continued, if the WOL setting set information indicates that WOL is set (i.e., if the WOL enabling bit is set in the NVRAM 130, in the present example), the state controlling unit 702 is configured to exercise control so as to transition into the WOL standby state (a state of the multifunction peripheral 1) in which the power supply to at least the controller 100 is stopped, while the power supply to the PHY 172 and to the low-power device microcomputer 500 is continued.

The WOL setting controlling unit 703 is configured to exercise control so as to set WOL before the transition into the WOL standby state. The WOL setting controlling unit 703 exercises control so as to, at least, set the MAC address, which is the physical address uniquely assigned to the multifunction peripheral 1, into the PHY 172.

The WOL setting storage controlling unit 704 is configured to exercise control so that, upon transition into the WOL standby state, WOL setting enabling information (a WOL enabling bit explained later in the present example) indicating that WOL has been set, into a non-volatile memory (the FRAM 504 in the present example).

The display controlling unit 705 is configured to exercise control so that various types of information are displayed on the LCD 210 of the operation panel 200. As explained in detail later, when the WOL setting controlling unit 703 exercises control so as to set WOL, the display controlling unit 705 exercises control so as to cause the LCD 210 to display that WOL is currently set. Further, when the power supply from the external power source is started without issuance of a signal that triggers the power supply to start (e.g., the button pressing notification signal explained later or the WOL notification signal explained later), while the WOL setting enabling information is not set (i.e., when an unexpected start-up has occurred), the display controlling unit 705 exercises control so as to cause the LCD 210 to display that the multifunction peripheral 1 will immediately shut down.

As explained in detail later, in the present embodiment, when the power supply from the external power source to the low-power device microcomputer 500 is started upon connecting the power plug 620 or upon recovery from a power outage, while the WOL enabling bit (an example of the WOL setting enabling information) is stored in the FRAM 504, the low-power device microcomputer 500 starts the power supply to at least the controller 100, and the WOL setting controlling unit 703 exercises control so as to set WOL. Further, after the WOL setting controlling unit 703 exercises control so as to set WOL, the state controlling unit 702 exercises control so as to cause the multifunction peripheral 1 to transition into the WOL standby state.

In the present embodiment, the functions of the WOL setting unit 701, the state controlling unit 702, the WOL setting controlling unit 703, and the display controlling unit 705 described above are realized by the controller 100; however, possible embodiments are not limited to this example. In the present example, the functions of the WOL setting unit 701, the state controlling unit 702, the WOL setting controlling unit 703, and the display controlling unit 705 are realized as a result of the CPU 110 included in the controller 100 executing a computer program stored in, for example, the NAND flash memory 150 or the like. In the present example, the functions of the WOL setting unit 701 described above are provided by the state management module 30; the functions of the state controlling unit 702 described above are provided by the state controlling driver 14; the functions of the WOL setting controlling unit 703 described above are provided by the NIC driver 12; and the functions of the display controlling unit 705 described above are provided by the state management module 30. However, possible embodiments are not limited to this example. For instance, at least a part of the above functions of the WOL setting unit 701, the state controlling unit 702, the WOL setting controlling unit 703, and the display controlling unit 705 may be realized by using a dedicated hardware circuit (e.g., a semiconductor integrated circuit).

Further, in the present embodiment, the functions of the WOL setting storage controlling unit 704 described above are realized by the low-power device microcomputer 500. In the present example, the functions of the WOL setting storage controlling unit 704 described above are realized as a result of the CPU 501 included in the low-power device microcomputer 500 executing a computer program stored in, for example, the ROM 503. However, possible embodiments are not limited to this example. For instance, the above functions of the WOL setting storage controlling unit 704 may be realized by using a dedicated hardware circuit (e.g., a semiconductor integrated circuit).

Next, a specific example of an operation performed by the multifunction peripheral 1 according to the present embodiment will be explained. FIG. 5 is a flowchart of an exemplary operation performed by the multifunction peripheral 1 when determining whether WOL should be set or not. First, the display controlling unit 705 exercises control so as to cause the LCD 210 of the operation panel 200 to display a setting screen used for receiving an instruction to set WOL, in response to an operation performed by the user (step S1). Subsequently, when an instruction to set WOL has been received (step S2: Yes), the WOL setting unit 701 (the state management module 30) sets a WOL enabling bit into the NVRAM 130 (step S3). On the contrary, when an instruction not to set WOL has been received (step S2: No), the WOL setting unit 701 (the state management module 30) clears the WOL enabling bit in the NVRAM 130, without setting any WOL enabling bit in the NVRAM 130 (step S4). The types of applications 40 with which it is possible to set WOL can arbitrarily be selected. One or more from among the copier application, the printer application, the fax application, and the scanner application may be selected.

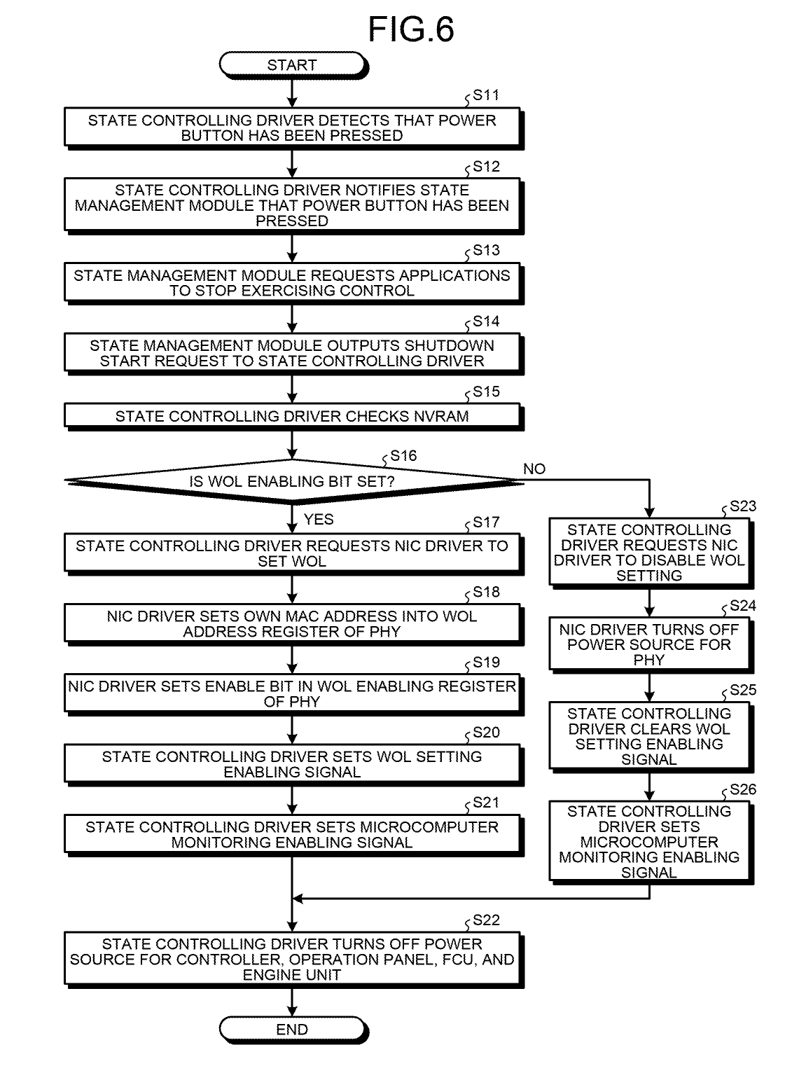

FIG. 6 is a flowchart of an exemplary operation performed by the multifunction peripheral 1 when shutting down. First, the state controlling driver 14 detects that the power button 610 has been pressed (step S11). In the present embodiment, when the user presses the power button 610 while power is being supplied to at least the controller 100 (e.g., in a regular state explained later), the voltage of the signal (a power button signal) supplied to a signal line connected to such a port among the general-purpose input/output ports of the ASIC 140 that corresponds to the pressing of the power button 610 changes to a voltage level indicating that the pressing of the power button 610 has occurred. Further, the state controlling driver 14 is able to detect that the power button 610 has been pressed, by reading the voltage of the one of the general-purpose input/output ports of the ASIC 140 that corresponds to the pressing of the button. Subsequently, the state controlling driver 14 notifies the state management module 30 that the power button 610 has been pressed (step S12).

After that, the state management module 30 requests the applications 40 to stop exercising control (step S13) and urges the applications 40 to transition into a state where it is possible to start a shutdown. In the present example, the “shutdown” refers to a process of stopping the power supply to at least the controller 100, while continuing the power supply to at least the low-power device microcomputer 500.

The state management module 30 outputs a shutdown start request to the state controlling driver 14, after confirming that the applications 40 have transitioned into the state where it is possible to start a shutdown (step S14). When having received the shutdown start request, the state controlling driver 14 checks the NVRAM 130 (step S15). If the WOL enabling bit described above is set in the NVRAM 130 (step S16: Yes), the state controlling driver 14 requests the NIC driver 12 to set WOL (requests to enable the WOL setting) (step S17). Having received the request, the NIC driver 12 sets the MAC address of its own (the MAC address of the multifunction peripheral 1) into a WOL address register of the PHY 172 (step S18). Subsequently, the NIC driver 12 sets an enable bit in the WOL enabling register of the PHY 172 (step S19) and notifies the state controlling driver 14 of the completion.

When having received the completion notification from the NIC driver 12, the state controlling driver 14 sets a WOL setting enabling signal indicating that the WOL setting is enabled (step S20). For example, the state controlling driver 14 is able to set the WOL setting enabling signal by setting the voltage of such a port among the general-purpose input/output ports of the ASIC 140 that corresponds to the WOL setting enabling signal to a voltage level (a predetermined voltage level) indicating that a WOL setting enabling signal has been issued. Further, the state controlling driver 14 sets a microcomputer monitoring enabling signal indicating that the power source monitoring process is transferred to the low-power device microcomputer 500, as information for the purpose of transferring the power source monitoring process to the low-power device microcomputer 500 (step S21). For example, the state controlling driver 14 is able to set the microcomputer monitoring enabling signal by setting the voltage of such a port among the general-purpose input/output ports of the ASIC 140 that corresponds to the microcomputer monitoring enabling signal to a voltage level (a predetermined voltage level) indicating that a microcomputer monitoring enabling signal has been issued.

After step S21 described above, the state controlling driver 14 stops the power supply to (turns off the power source for) the controller 100, the operation panel 200, the FCU 300, and the engine unit 400 (step S22). In the present embodiment, the state controlling driver 14 is able to cause the controller controlling SW 101 to transition into an OFF state and to stop the power supply to the controller 100, by setting the voltage of such a port among the general-purpose input/output ports of the ASIC 140 that corresponds to a signal controlling the signal that controls the controller controlling SW 101 to a voltage level that causes the controller controlling SW 101 to transition into the OFF state. Similarly, the state controlling driver 14 sets the voltage of such a port among the general-purpose input/output ports of the ASIC 140 that corresponds to a signal controlling the operation panel controlling SW 230 to a voltage level that causes the operation panel controlling SW 230 to transition into an OFF state, and sets the voltage of such a port that corresponds to a signal controlling the FCU controlling SW 310 to a voltage level that causes the FCU controlling SW 310 transition into an OFF state, and further sets the voltage of such a port that corresponds to a signal controlling the engine controlling SW 410 to a voltage level that causes the engine controlling SW 410 to transition into an OFF state.

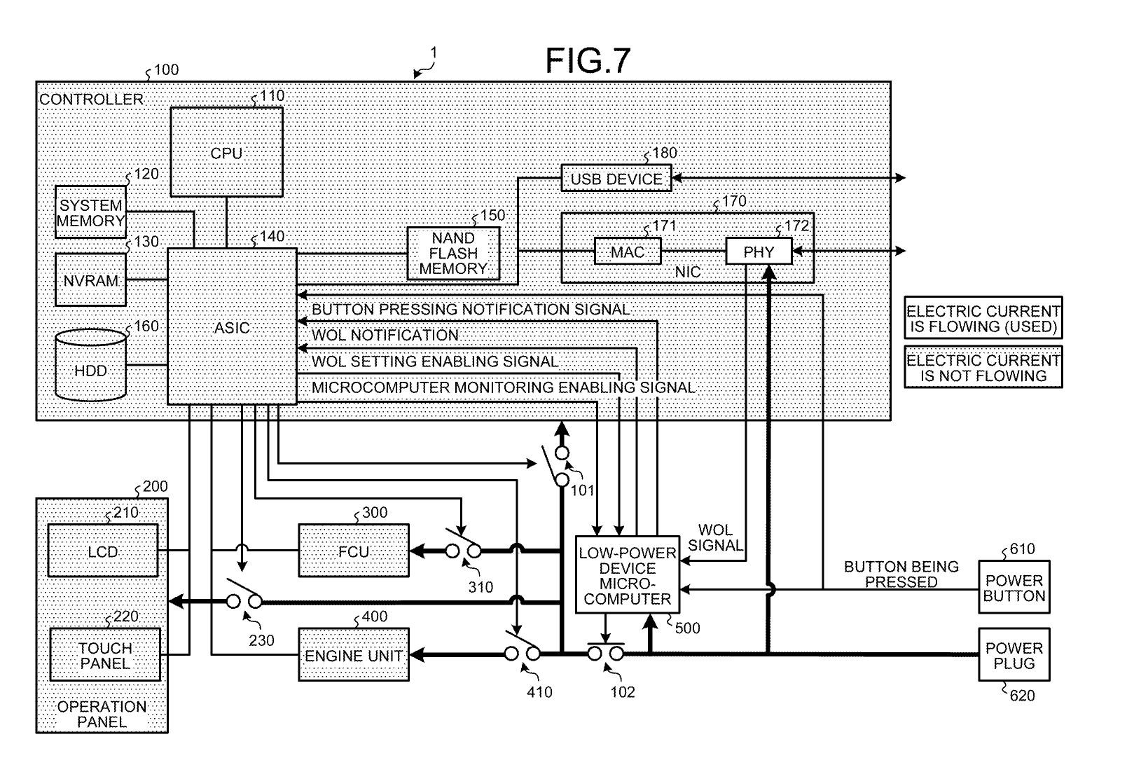

When the multifunction peripheral 1 shuts down while WOL is set as described above, the multifunction peripheral 1 is in a state in which, as illustrated in FIG. 7, the power supply to the low-power device microcomputer 500 and to the PHY 172 is continued, while the power supply to the other elements (the controller 100 and the like) is stopped. In the present embodiment, the state illustrated in FIG. 7 will be referred to as the “WOL standby state”. In the WOL standby state, because the electric current continues to flow through the PHY 172, the PHY 172 is able to notify the low-power device microcomputer 500 of the WOL signal through the receiving of the magic packet. Further, by detecting the pressing of the power button 610 or the issuance of the WOL signal, the low-power device microcomputer 500 is able to resume the power supply to certain functional units (at least an element other than the low-power device microcomputer 500 and the PHY 172) of the multifunction peripheral 1.

Returning to the description of FIG. 6, when the WOL enabling bit described above is not set in the NVRAM 130 at step S16 (step S16: No), the state controlling driver 14 requests the NIC driver 12 to disable the WOL setting (step S23). Having received the request, the NIC driver 12 stops the power supply to (turns off the power source for) the PHY 172 (step S24). Subsequently, the state controlling driver 14 clears the WOL setting enabling signal (step S25). For example, the state controlling driver 14 is able to clear the WOL setting enabling signal by setting the voltage of such a port among the general-purpose input/output ports of the ASIC 140 to a voltage level (a predetermined voltage level) indicating that the WOL setting enabling signal is not issued. After that, the state controlling driver 14 sets a microcomputer monitoring enabling signal indicating that the power source monitoring process is transferred to the low-power device microcomputer 500, as information for the purpose of transferring the power source monitoring process to the low-power device microcomputer 500 (step S26).

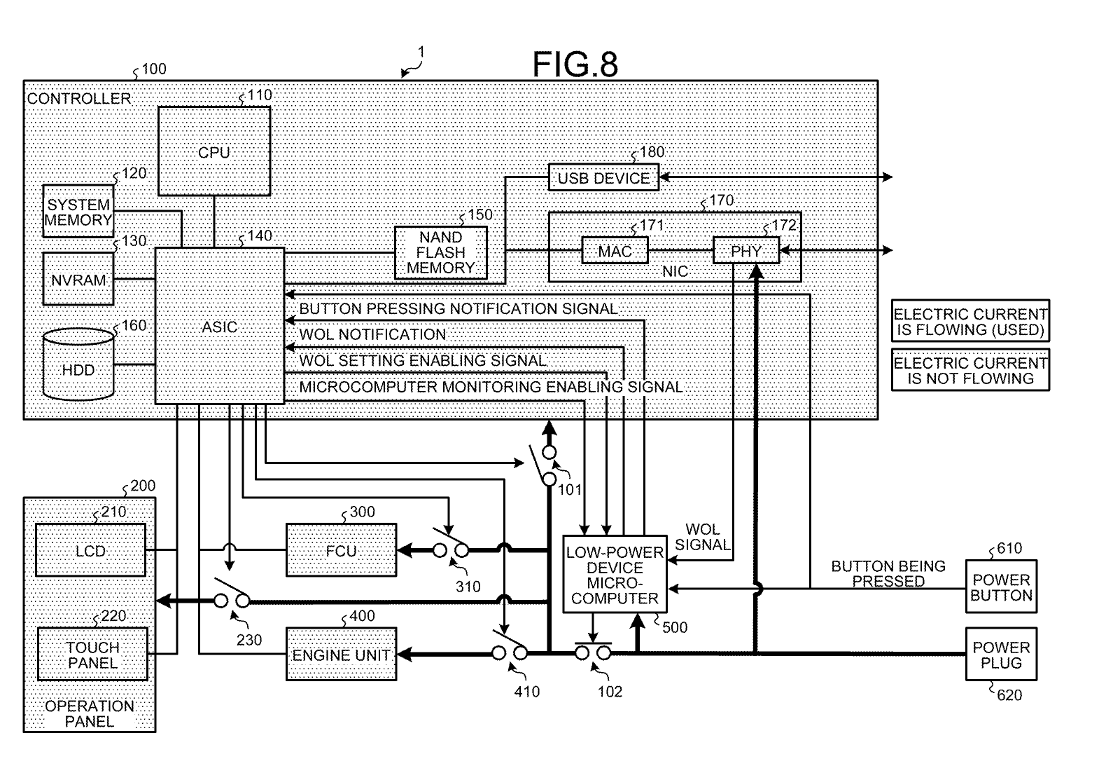

After step S26 described above, the state controlling driver 14 stops the power supply to (turns off the power source for) the controller 100, the operation panel 200, the FCU 300, and the engine unit 400 (step S22). When the multifunction peripheral 1 shuts down without WOL being set as explained above, the multifunction peripheral 1 is in a state in which, as illustrated in FIG. 8, the power supply only to the low-power device microcomputer 500 is continued, while the power supply to the other elements (the controller 100 and the like) is stopped. When transitioned into this state, the low-power device microcomputer 500 is able to resume the power supply to certain functional units (at least an element other than the low-power device microcomputer 500) of the multifunction peripheral 1, by detecting the pressing of the power button 610.

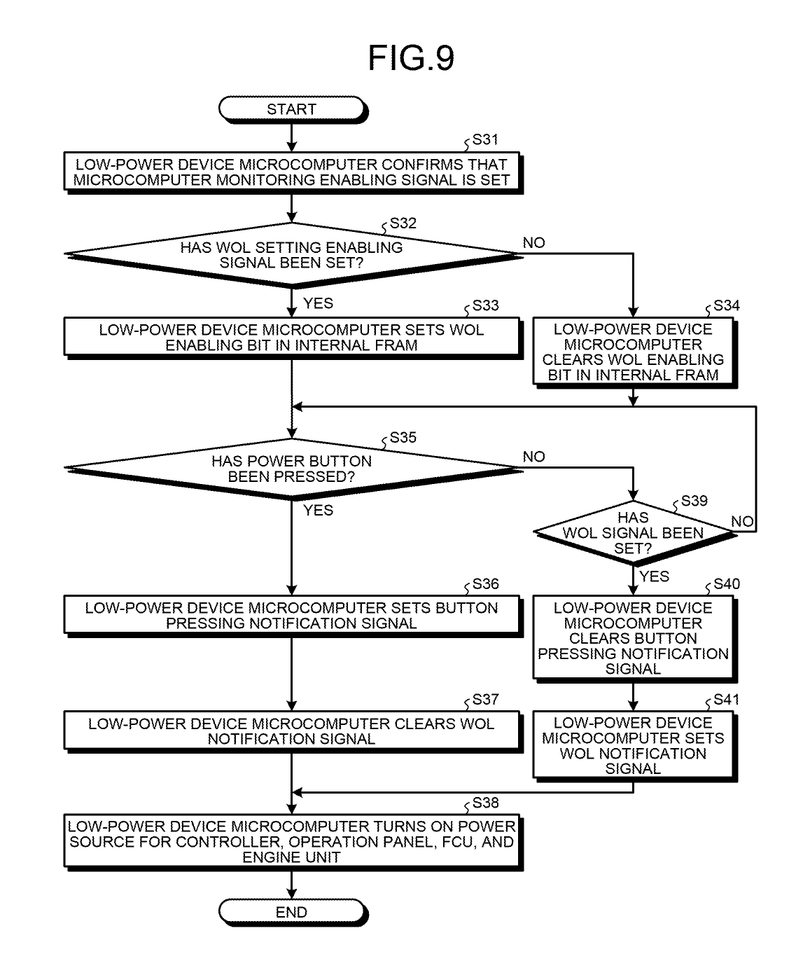

Next, an operation performed by the low-power device microcomputer 500 after a shutdown will be explained. FIG. 9 is a flowchart of an exemplary operation performed by the low-power device microcomputer 500 after a shutdown. First, the low-power device microcomputer 500 confirms that the microcomputer monitoring enabling signal is set (step S31). For example, the low-power device microcomputer 500 is able to confirm that the microcomputer monitoring enabling signal is set, by reading the voltage of such a port in the GPIO 506 that corresponds to the microcomputer monitoring enabling signal. Subsequently, the low-power device microcomputer 500 (the WOL setting storage controlling unit 704) checks to see whether or not the WOL setting enabling signal has been set (step S32). For example, the low-power device microcomputer 500 is able to check to see whether the WOL setting enabling signal has been set or not, by reading the voltage of such a port of the GPIO 506 that corresponds to the WOL setting enabling signal.

When the WOL setting enabling signal has been set (step S32: Yes), the low-power device microcomputer 500 (the WOL setting storage controlling unit 704) understands that the multifunction peripheral shut down while WOL was set and sets a WOL enabling bit indicating that WOL was set, into the FRAM 504 provided therein (step S33). On the contrary, if the WOL setting enabling signal has not been set in step S32 described above (step S32: No), the low-power device microcomputer 500 clears the WOL enabling bit in the FRAM 504 provided therein, without setting any WOL enabling bit in the FRAM 504 provided therein (step S34).

After that, the low-power device microcomputer 500 starts monitoring an event where the power source of the multifunction peripheral 1 is turned on. First, the low-power device microcomputer 500 checks to see whether the power button 610 has been pressed or not (step S35). For example, the low-power device microcomputer 500 is able to check to see whether the power button 610 has been pressed or not, by monitoring the voltage of such a port of the GPIO 506 that corresponds to the pressing of the power button 610 and checking to see whether or not the voltage of the port has changed to a voltage level indicating that the pressing of the button has occurred.

When the power button 610 has been pressed (step S35: Yes), the low-power device microcomputer 500 sets a button pressing notification signal (step S36). For example, the low-power device microcomputer 500 sets the voltage of such a port of the GPIO 506 that corresponds to the button pressing notification signal to a voltage level (a predetermined voltage level) indicating that the button pressing notification signal has been issued. Subsequently, the low-power device microcomputer 500 clears the WOL notification signal (step S37). For example, the low-power device microcomputer 500 sets the voltage of such a port of the GPIO 506 that corresponds to the WOL notification signal to a voltage level indicating that the WOL notification signal is not issued.

After step S37 described above, the low-power device microcomputer 500 starts the power supply to (turns on the power source for) the controller 100, the operation panel 200, the FCU 300, and the engine unit 400 (step S38). In the present embodiment, the low-power device microcomputer 500 sets the voltage of such a port of the GPIO 506 that corresponds to a relay signal to a voltage level that causes the relay SW 102 to transition into an ON state. As a result, the relay SW 102 transitions into the ON state. In conjunction with the relay SW 102 being turned on, the controller controlling SW 101, the operation panel controlling SW 230, the FCU controlling SW 310, and the engine controlling SW 410 each transition into an ON state. As a result, the power supply to the controller 100, the operation panel 200, the FCU 300, and the engine unit 400 is started.

On the contrary, when the power button 610 has not been pressed at step S35 described above (step S35: No), the low-power device microcomputer 500 checks to see whether the PHY 172 has set a WOL signal or not (step S39). For example, the low-power device microcomputer 500 is able to check to see whether a WOL signal has been set or not, by monitoring the voltage of such a port of the GPIO 506 that corresponds to the WOL signal and checking to see whether or not the voltage of the port is at the voltage level indicating that a WOL signal has been issued.

When the WOL signal has been set (step S39: Yes), the low-power device microcomputer 500 clears the button pressing notification signal (step S40). For example, the low-power device microcomputer 500 sets the voltage of such a port of the GPIO 506 that corresponds to the button pressing notification signal to a voltage level indicating that no button pressing notification signal is issued. Subsequently, the low-power device microcomputer 500 sets a WOL notification signal (step S41). For example, the low-power device microcomputer 500 sets the voltage of such a port of the GPIO 506 that corresponds to the WOL notification signal to a voltage level indicating that a WOL notification signal has been issued. After that, the low-power device microcomputer 500 starts the power supply to (turns on the power source for) the controller 100, the operation panel 200, the FCU 300, and the engine unit 400 (step S38).

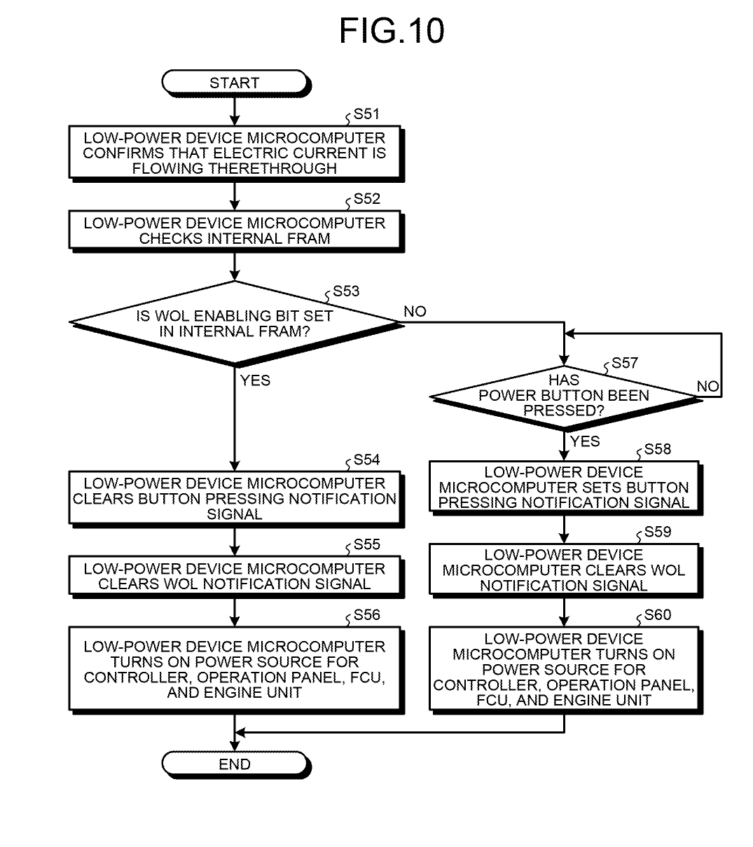

Subsequently, an operation performed by the low-power device microcomputer 500 when the power supply from the external power source to the low-power device microcomputer 500 is started, upon connecting the power plug 620 or upon recovery from a power outage will be explained. FIG. 10 is a flowchart of an exemplary operation performed by the low-power device microcomputer 500 when the power supply from the external source to the low-power device microcomputer 500 is started upon connecting the power plug 620 or upon recovery from a power outage. As illustrated in FIG. 10, the low-power device microcomputer 500 first confirms that an electric current is flowing therethrough (step S51). Subsequently, the low-power device microcomputer 500 checks the FRAM 504 provided therein (step S52) and checks to see whether a WOL enabling bit is set in the FRAM 504 or not (step S53).

When a WOL enabling bit is set in the FRAM 504 (step S53: Yes), the low-power device microcomputer 500 determines that it is necessary to reset a WOL enabling bit because the power was cut off while the WOL enabling bit was set and starts a start-up of the multifunction peripheral 1. In that situation, the low-power device microcomputer 500 clears the button pressing notification signal in order to notify the multifunction peripheral start-up unit 20 of a method for starting up the multifunction peripheral 1 (step S54) and clears the WOL notification signal (step S55). For example, the low-power device microcomputer 500 is able to clear the button pressing notification signal, by setting the voltage of such a port of the GPIO 506 that corresponds to the button pressing notification signal to a voltage level indicating that no button pressing notification signal is issued. Further, for example, the low-power device microcomputer 500 is able to clear the WOL notification signal by setting the voltage of such a port of the GPIO 506 that corresponds to the WOL notification signal to a voltage level indicating that a WOL notification signal has been issued.

Subsequently, the low-power device microcomputer 500 starts the power supply to (turns on the power source for) the controller 100, the operation panel 200, the FCU 300, and the engine unit 400 (step S56). As explained above, in the present embodiment, the low-power device microcomputer 500 sets the voltage of such a port of the GPIO 506 that corresponds to the relay signal to a voltage level that causes the relay SW 102 to transition into the ON state. As a result, the relay SW 102 transitions into the ON state. Further, in conjunction with the relay SW 102 being turned on, the controller controlling SW 101, the operation panel controlling SW 230, the FCU controlling SW 310, and the engine controlling SW 410 each transition into an ON state. As a result, the power supply to the controller 100, the operation panel 200, the FCU 300, and the engine unit 400 is started (resumed).

On the contrary, at step S53 described above, if the WOL enabling bit is not set in the FRAM 504 (step S53: No), the low-power device microcomputer 500 determines that it is unnecessary to set WOL and checks to see whether or not the power button 610 has been pressed (step S57). If the power button 610 has been pressed (step S57: Yes), the low-power device microcomputer 500 sets a button pressing notification signal (step S58). For example, the low-power device microcomputer 500 sets the voltage of such a port of the GPIO 506 that corresponds to the button pressing notification signal to a voltage level indicating that a button pressing notification signal has been issued. Subsequently, the low-power device microcomputer 500 clears the WOL notification signal (step S59). For example, the low-power device microcomputer 500 sets the voltage of such a port of the GPIO 506 that corresponds to the WOL notification signal to a voltage level indicating that the WOL notification signal is not issued. Subsequently, the low-power device microcomputer 500 starts the power supply to (turns on the power source for) the controller 100, the operation panel 200, the FCU 300, and the engine unit 400 (step S60).

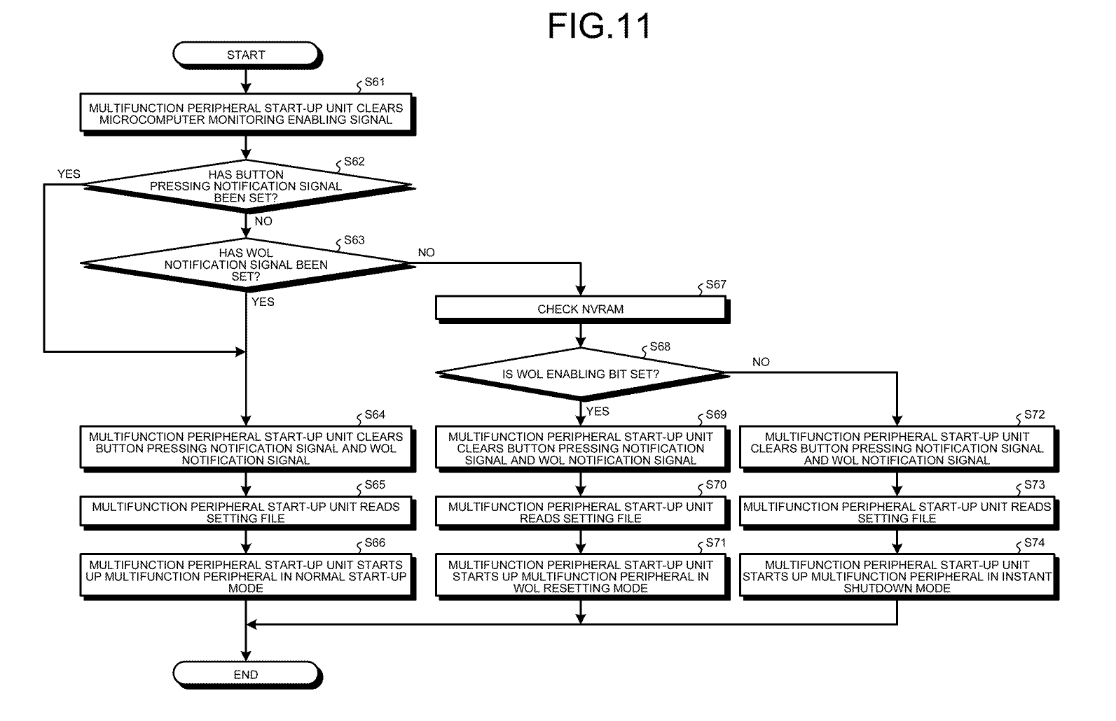

Next, an operation performed by the multifunction peripheral 1 when the power supply to the controller 100 is started will be explained. FIG. 11 is a flowchart of an example of a process performed by the multifunction peripheral start-up unit 20 when the power supply to the controller 100 is started. As illustrated in FIG. 11, the multifunction peripheral start-up unit 20 first clears the microcomputer monitoring enabling signal (step S61). For example, the multifunction peripheral start-up unit 20 sets the voltage of such a port among the general-purpose input/output ports of the ASIC 140 that corresponds to the microcomputer monitoring enabling signal to a voltage level indicating that no microcomputer monitoring enabling signal is issued. Subsequently, the multifunction peripheral start-up unit 20 checks to see whether a button pressing notification signal has been set or not (step S62). For example, the multifunction peripheral start-up unit 20 is able to check to see whether the button pressing notification signal has been set or not, by checking to see whether the voltage of such a port among the general-purpose input/output ports of the ASIC 140 that corresponds to the button pressing notification signal is at a voltage level indicating that a button pressing notification signal has been issued.

When no button pressing notification signal has been set (step S62: No), the multifunction peripheral start-up unit 20 checks to see whether a WOL notification signal has been set or not (step S63). For example, the multifunction peripheral start-up unit 20 is able to check to see whether the WOL notification signal has been set or not, by checking to see whether the voltage of such a port among the general-purpose input/output ports of the ASIC 140 that corresponds to the WOL notification signal is at a voltage level indicating that a WOL notification signal has been issued.

When a button pressing notification signal has been set (step S62: Yes), or when a WOL notification signal has been set (step S63: Yes), the multifunction peripheral start-up unit 20 determines that the start-up is a normal start-up and first clears the button pressing notification signal and the WOL notification signal so as to return the state to an initial state (step S64). For example, the multifunction peripheral start-up unit 20 is able to return the state to the initial state by setting the voltage of such a port among the general-purpose input/output ports of the ASIC 140 that corresponds to the button pressing notification signal to a voltage level indicating that no button pressing notification signal is issued and setting the voltage of such a port that corresponds to the WOL notification signal to a voltage level indicating that the WOL notification signal is not issued.

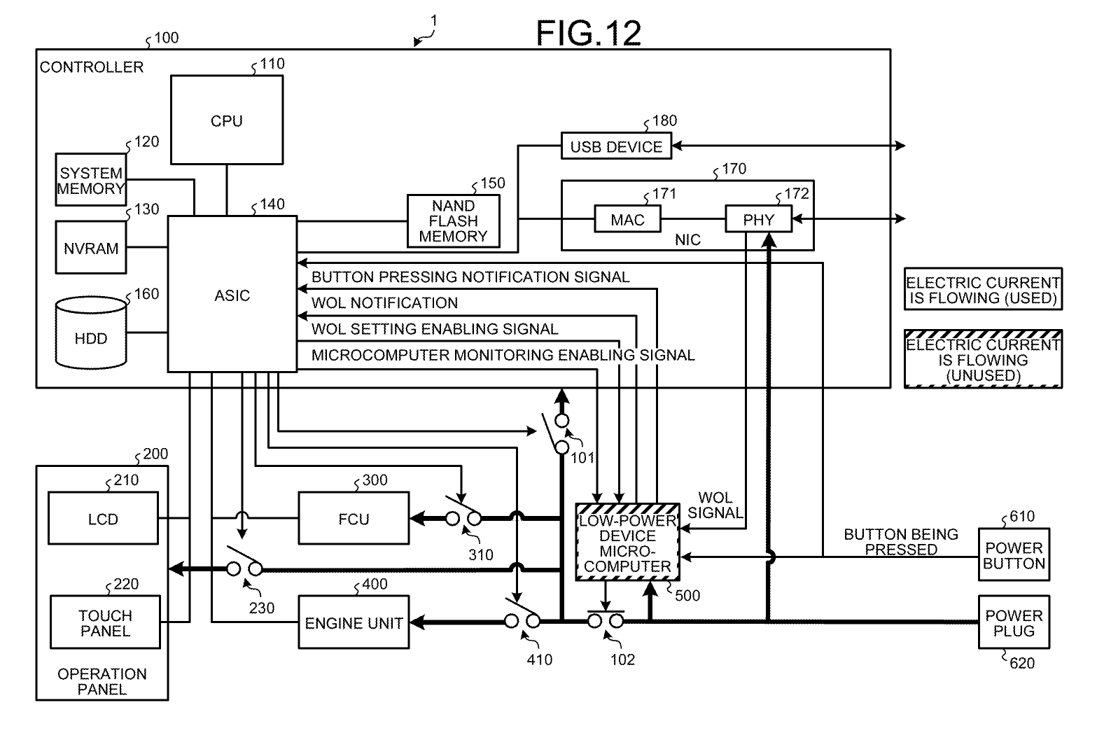

Subsequently, the multifunction peripheral start-up unit 20 reads the setting file (step S65) and starts up the multifunction peripheral 1 in a normal start-up mode (step S66). Details of the setting file will be explained later. In the present example, when the multifunction peripheral 1 is started up in the normal start-up mode, the multifunction peripheral 1 transitions into a state (called a “regular state”, in the present example) in which, as illustrated in FIG. 12, the electric current is arranged to flow through all the elements included in the multifunction peripheral 1. In the regular state, because the microcomputer monitoring enabling signal is cleared, the low-power device microcomputer 500 does not perform the power source monitoring process or the like (does not perform anything). For this reason, the pressing of the power button 610 is detected not by the low-power device microcomputer 500, but by the state controlling driver 14, which monitors such a port among the general-purpose input/output ports of the ASIC 140 that corresponds to the pressing of the power button 610.

Returning to the description of FIG. 11, when no button pressing notification signal has been set (step S62: No), and also, the WOL notification signal has not been set (step S63: No), the multifunction peripheral start-up unit 20 checks the NVRAM 130 included in the controller 100 (step S67), and checks to see whether or not a WOL enabling bit is set in the NVRAM 130 (step S68).

If a WOL enabling bit is set (step S68: Yes), the multifunction peripheral start-up unit 20 determines that a start-up is performed for resetting WOL and first clears the button pressing notification signal and the WOL notification signal so as to return the state to the initial state (step S69). Subsequently, the multifunction peripheral start-up unit 20 reads the setting file (step S70) and starts up the multifunction peripheral 1 in a WOL resetting mode (step S71).

On the contrary, if the WOL enabling bit is not set at step S68 above (step S68: No), the multifunction peripheral start-up unit 20 determines that an unexpected start-up has occurred and first clears the button pressing notification signal and the WOL notification signal so as to return the state to the initial state (step S72). Subsequently, the multifunction peripheral start-up unit 20 reads the setting file (step S73) and starts up the multifunction peripheral 1 in an instant shutdown mode (step S74).

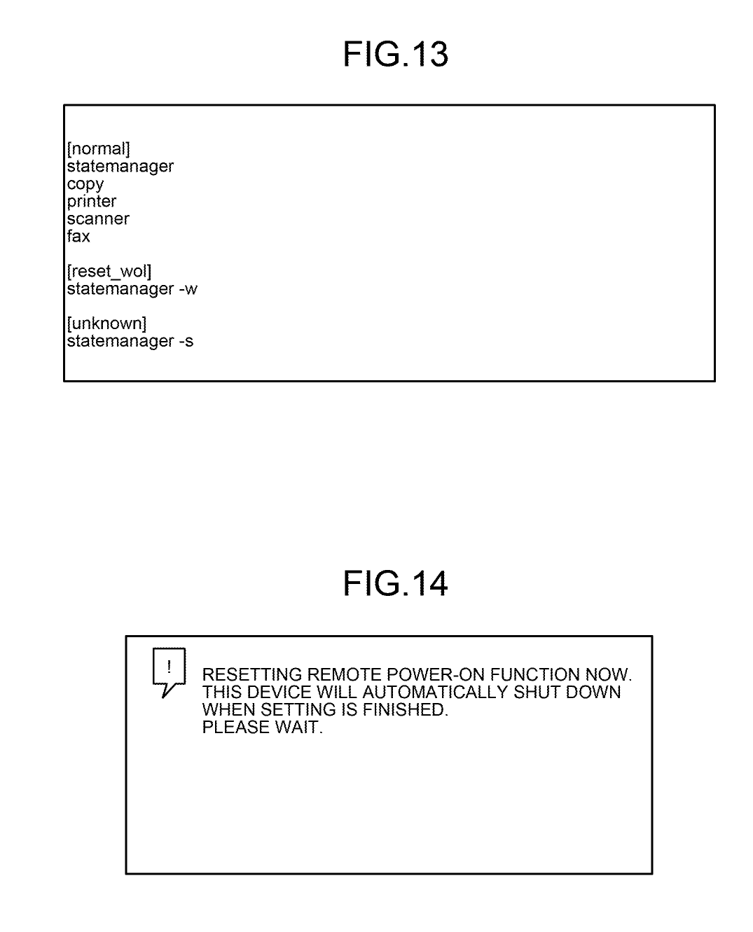

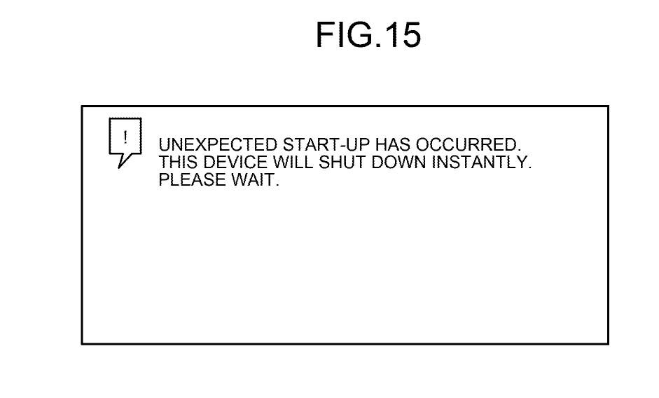

FIG. 13 is a drawing of an example of the setting file. In the present example, processes in the normal start-up mode are performed according to what is written in a normal label; processes in the WOL resetting mode are performed according to what is written in a reset wol label; and processes in the instant shutdown mode are performed according to what is written in an unknown label (i.e., a state that is not known). In the normal start-up mode, all the pieces of software including the applications 40 and the state management module 30 are started up. In the WOL resetting mode, only “statemanager” is started up with a “-w option”. In the instant shutdown mode, only “statemanager” is started up with a “-s option”. In this manner, the behaviors are changed for each mode. In this situation, “statemanager” corresponds to the state management module 30. When “statemanager” is started up with the “-w option”, WOL is currently set is displayed on the LCD 210 as illustrated in FIG. 14, so that the shutdown process illustrated at step S13 and thereafter in FIG. 6 is performed. In contrast, when “statemanager” is started up with the “-s option”, the multifunction peripheral 1 is to instantly shut down due to an unexpected start-up is displayed on the LCD 210 as illustrated in FIG. 15, so that the shutdown process illustrated at step S13 and thereafter in FIG. 6 is performed. If the time period before the shutdown is short, it is not necessary to display the information on the LCD 210.

As explained above, in the present embodiment, upon transition into the WOL standby state, the WOL enabling bit indicating that WOL has been set is stored in the FRAM 504 provided in the low-power device microcomputer 500. With this arrangement, even if the external power source is cut off, it is possible, when the external power source is recovered, to bring the multifunction peripheral 1 back into the state where it is possible to turn on the power source with WOL, by using the WOL enabling bit stored in the FRAM 504 provided in the low-power device microcomputer 500. More specifically, as explained above, when the power supply from the external power source to the low-power device microcomputer 500 is started upon connecting the power plug 620 or upon recovery from a power outage, if the WOL enabling bit is stored in the FRAM 504 provided in the low-power device microcomputer 500, the low-power device microcomputer 500 starts the power supply to the controller 100, the operation panel 200, the FCU 300, and the engine unit 400, so that the WOL setting controlling unit 703 (the NIC driver 12) exercises control so as to set WOL. Further, after WOL is set, the state controlling unit 702 (the state controlling driver 14) exercises control so as to cause the multifunction peripheral 1 to transition into the WOL standby state again. In this manner, even if the external power source is cut off while WOL is set, it is possible to bring the multifunction peripheral 1 into the state where it is possible to turn on the power source with WOL.

### Second Embodiment

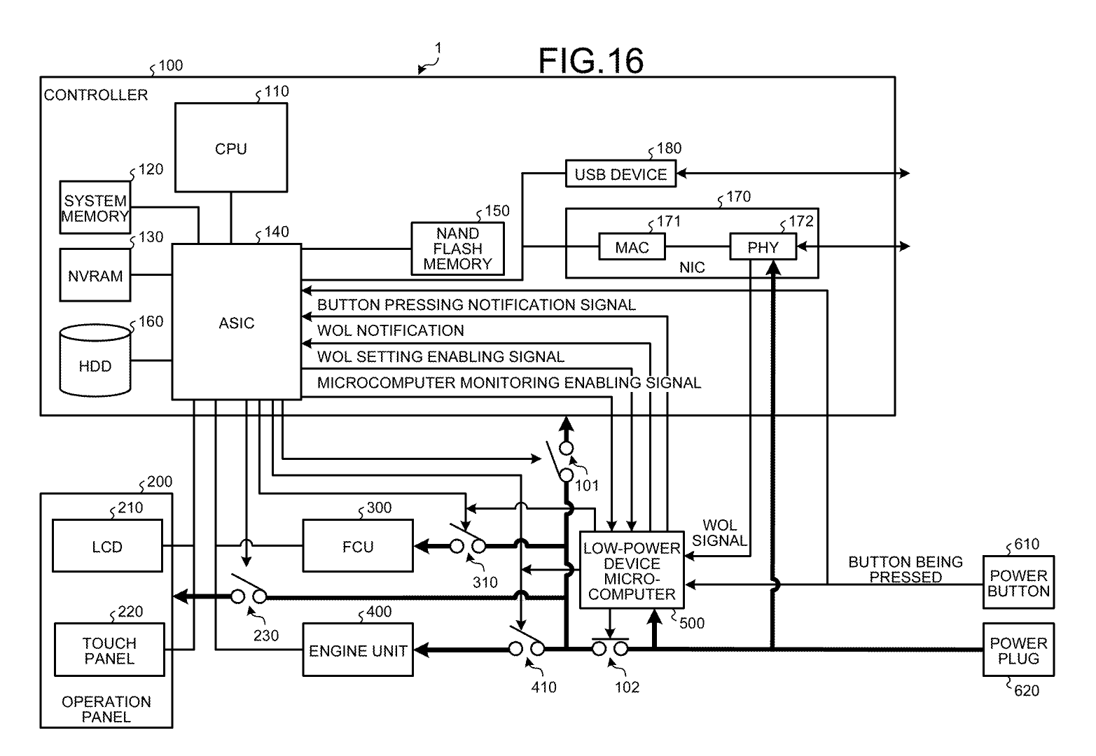

Next, a second embodiment will be explained. Explanation of some of the features that are the same as those in the first embodiment above will be omitted. FIG. 16 is a diagram of an exemplary hardware configuration of the multifunction peripheral 1 according to the present embodiment. In the present embodiment, the low-power device microcomputer 500 is capable of switching on and off the FCU controlling SW 310 and the engine controlling SW 410.

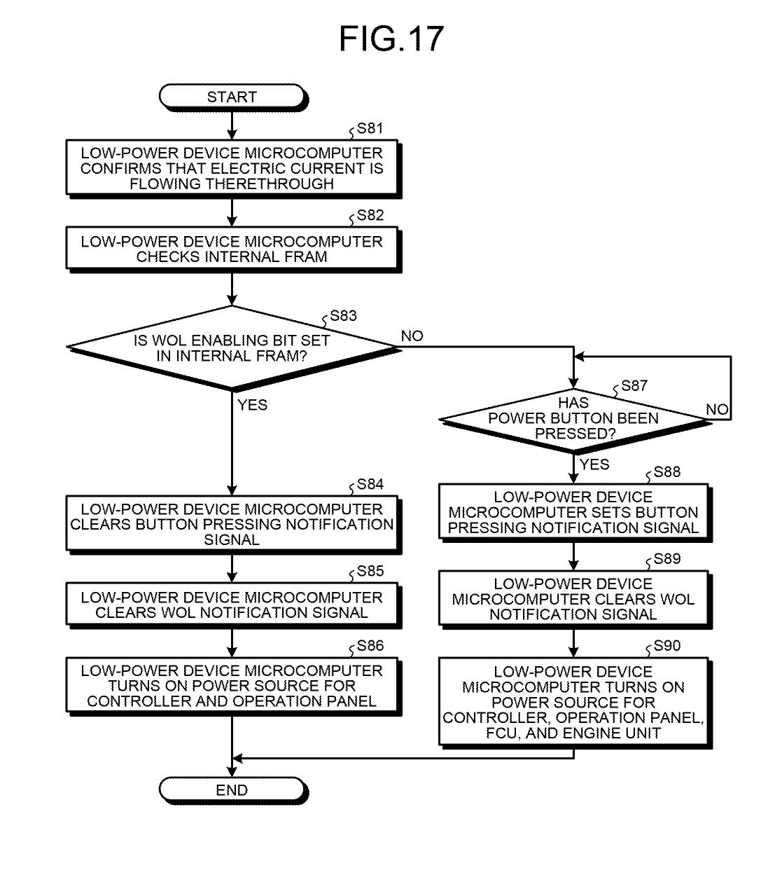

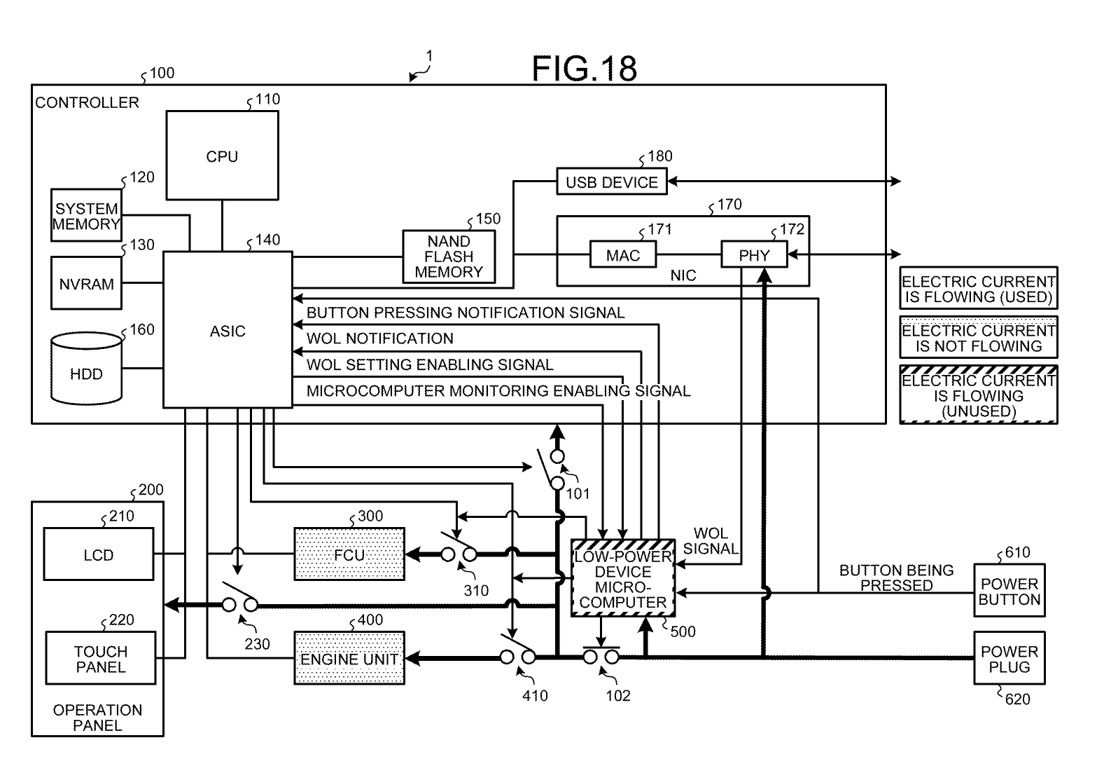

FIG. 17 is a flowchart of an exemplary operation performed by the low-power device microcomputer 500 when the power supply from the external power source to the low-power device microcomputer 500 is started upon connecting the power plug 620 or upon recovery from a power outage. Because the processes other than the process at step S86 in FIG. 17 are the same as those in FIG. 10, detailed explanation thereof will be omitted. At step S86 in FIG. 17, the low-power device microcomputer 500 exercises control so as to cause the relay SW 102 to transition into an ON state, while the FCU controlling SW 310 and the engine controlling SW 410 have each been caused to transition into an OFF state. As a result, the controller controlling SW 101 and the operation panel controlling SW 230 each transition into an ON state, whereas the FCU controlling SW 310 and the engine controlling SW 410 are each maintained in the OFF state. Accordingly, as illustrated in FIG. 18, the multifunction peripheral 1 transitions into the state in which the power supply to the controller 100 and the operation panel 200 is started, while the power supply to the FCU 300 and the engine unit 400 is stopped.

To summarize, when the power supply from the external power source to the low-power device microcomputer 500 is started upon connecting the power plug 620 or upon recovery from a power outage, if the WOL enabling bit is stored in the FRAM 504 provided in the low-power device microcomputer 500, it is sufficient if the low-power device microcomputer 500 is configured so that the power supply to at least the controller 100 can be started in order to reset WOL.

### Third Embodiment

Next, a third embodiment will be explained.

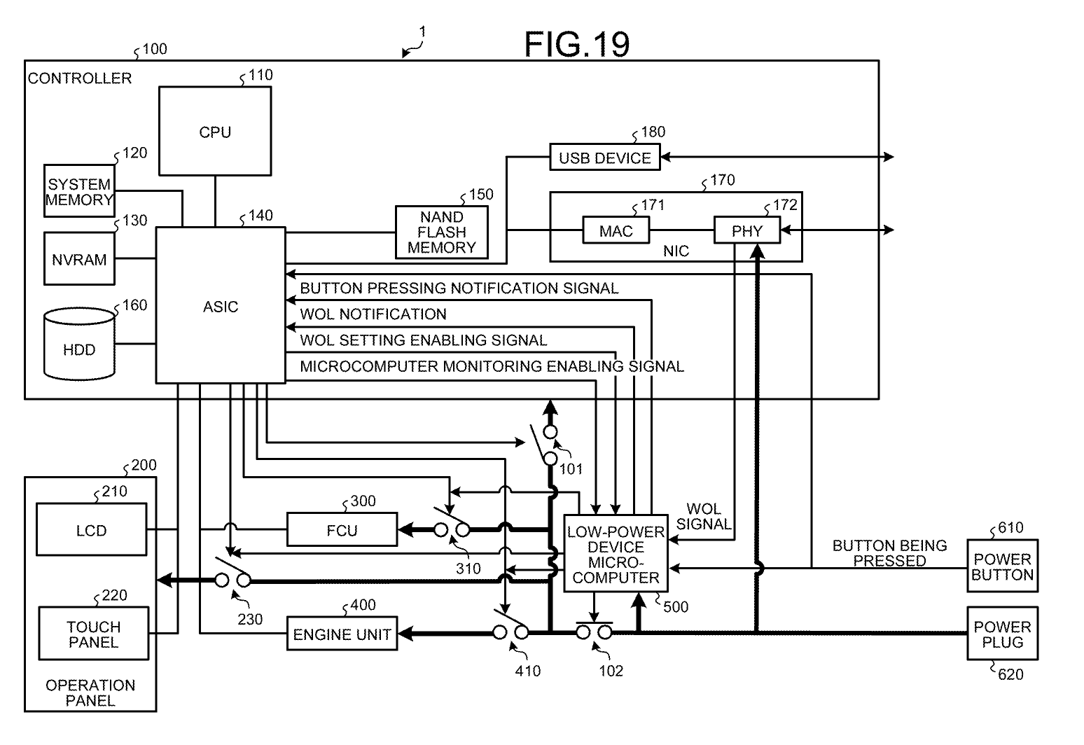

Explanation of some of the features that are the same as those in the first embodiment above will be omitted. FIG. 19 is a diagram of an exemplary hardware configuration of the multifunction peripheral 1 according to the present embodiment. In the present embodiment, the low-power device microcomputer 500 is capable of switching on and off the operation panel controlling SW 230, the FCU controlling SW 310, and the engine controlling SW 410.

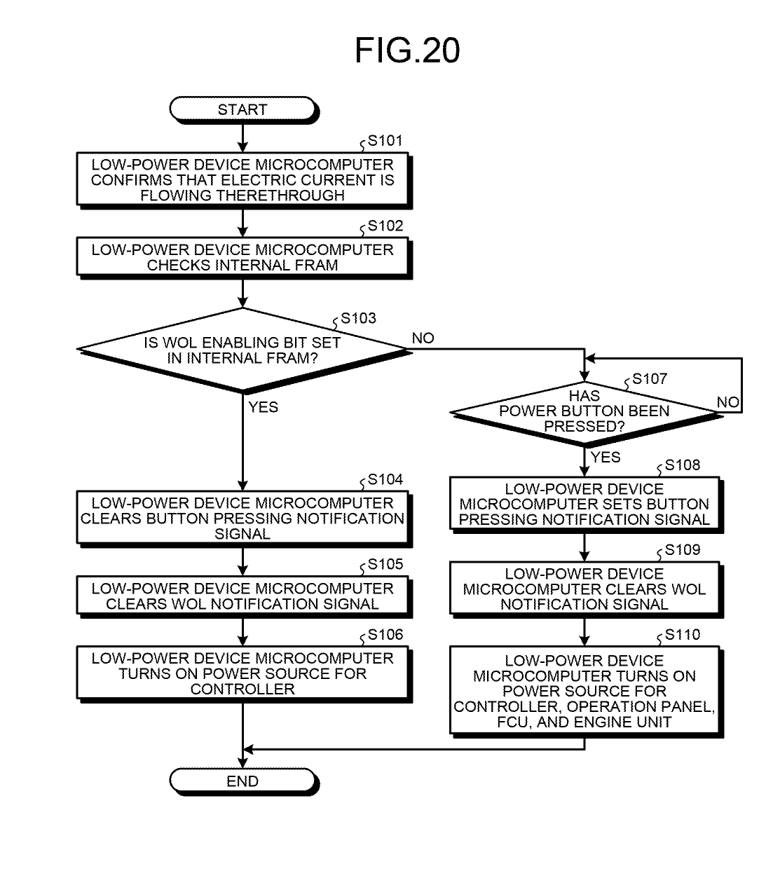

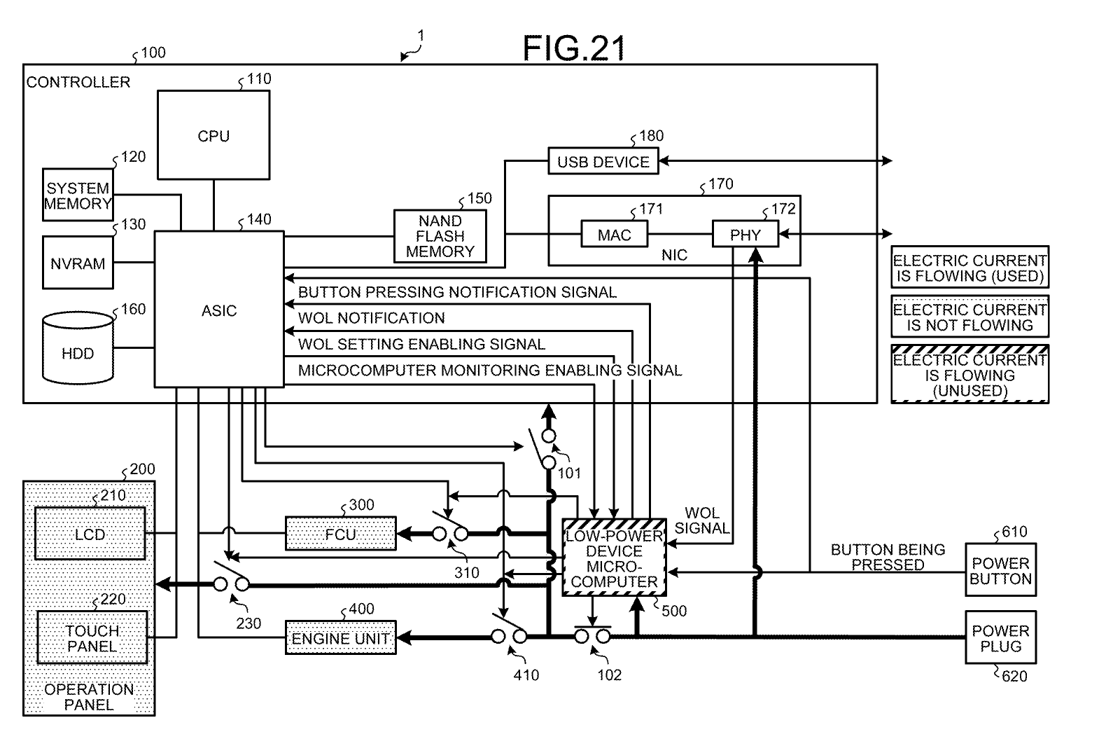

FIG. 20 is a flowchart of an exemplary operation performed by the low-power device microcomputer 500 when the power supply from the external power source to the low-power device microcomputer 500 is started upon connecting the power plug 620 or upon recovery from a power outage. Because the processes other than the process at step S106 in FIG. 20 are the same as those in FIG. 10, detailed explanation thereof will be omitted. At step S106 in FIG. 20, the low-power device microcomputer 500 exercises control so as to cause the relay SW 102 to transition into an ON state, while the operation panel controlling SW 230, the FCU controlling SW 310, and the engine controlling SW 410 have each been caused to transition into an OFF state. As a result, the controller controlling SW 101 transitions into an ON state, whereas the operation panel controlling SW 230, the FCU controlling SW 310, and the engine controlling SW 410 are each maintained in the OFF state. Accordingly, as illustrated in FIG. 21, the multifunction peripheral 1 transitions into the state in which the power supply to the controller 100 is started, while the power supply to the operation panel 200, the FCU 300, and the engine unit 400 is stopped.

To summarize, when the power supply from the external power source to the low-power device microcomputer 500 is started upon connecting the power plug 620 or upon recovery from a power outage, if the WOL enabling bit is stored in the FRAM 504 provided in the low-power device microcomputer 500, it is sufficient if the low-power device microcomputer 500 is configured so that the power supply to at least the controller 100 can be started in order to reset WOL. Further, in that situation, the low-power device microcomputer 500 does not supply power to the operation panel 200. In another example, the multifunction peripheral 1 may further include an expansion processing unit (a device that provides optional functions) that performs information processing in an expanded manner, while the low-power device microcomputer 500 is configured so as not to supply power to the expansion processing unit. With this arrangement, it is possible to inhibit wasteful power consumption and noise caused by initial processes performed on unnecessary sections.

### Fourth Embodiment

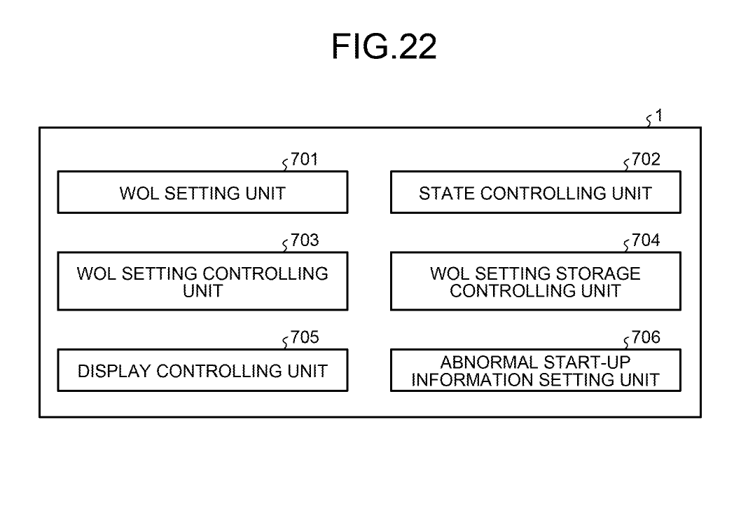

Next, a fourth embodiment will be explained. Explanation of some of the features that are the same as those in the first embodiment above will be omitted. FIG. 22 is a diagram of examples of functions of the multifunction peripheral 1 according to the present embodiment. As illustrated in FIG. 22, the multifunction peripheral 1 further includes an abnormal start-up information setting unit 706. When the power supply from the external source is started without issuance of a signal that triggers the power supply to start, if the WOL setting enabling information (the WOL enabling bit, in the present example) is not set (i.e., when an unexpected start-up has occurred), the abnormal start-up information setting unit 706 checks to see whether abnormal start-up information (called an “abnormal start-up bit” in the present example) indicating that the start-up is an abnormal start-up has already been set or not. If no abnormal start-up bit is set, the abnormal start-up information setting unit 706 exercises control so as to set an abnormal start-up bit. In the present example, functions of the abnormal start-up information controlling unit 706 are provided by the multifunction peripheral start-up unit 20; however, possible embodiments are not limited to this example.

Further, when the abnormal start-up information setting unit 706 exercises control to set the abnormal start-up bit (i.e., when an unexpected start-up occurs for the first time), the display controlling unit 705 exercises control so as to cause the LCD 210 to display that the multifunction peripheral 1 is to shut down. Further, when the abnormal start-up information controlling unit 706 does not exercise control so as to set an abnormal start-up bit, but an abnormal start-up bit has already been set (i.e., when an unexpected startup occurs for the second or more time), the display controlling unit 705 exercises control so as to cause the LCD 21 to display that the multifunction peripheral 1 is in an abnormal state.

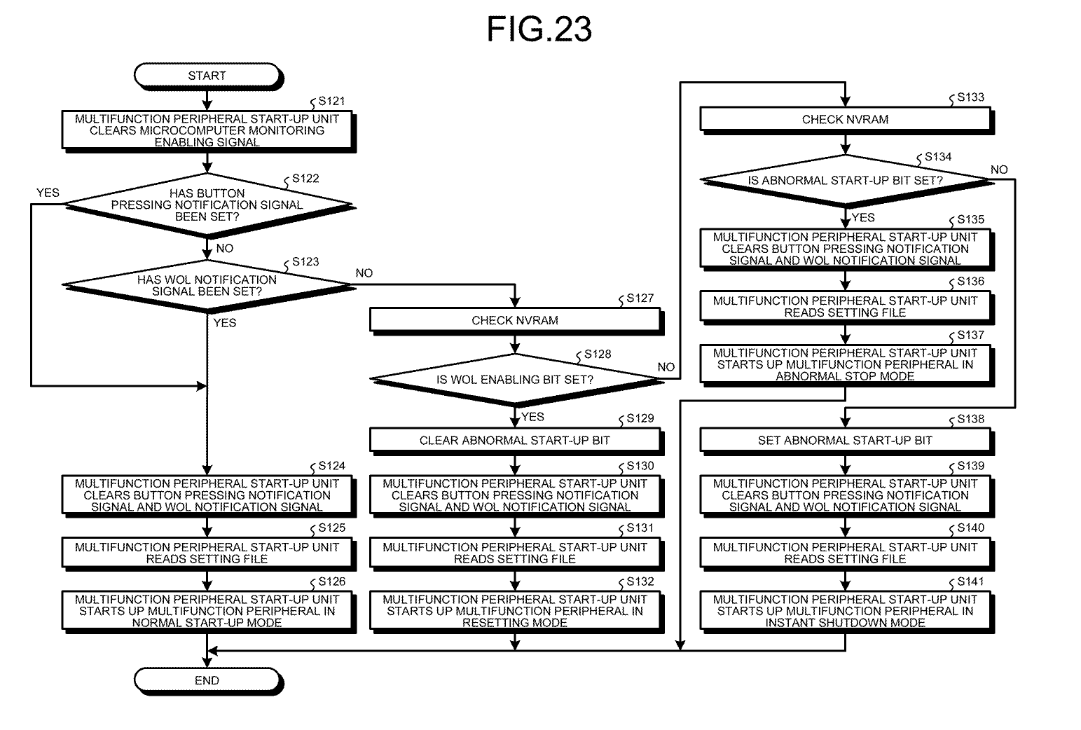

FIG. 23 is a flowchart of an example of a process performed by the multifunction peripheral start-up unit 20 according to the present embodiment when the power supply to the controller 100 is started. The processes at steps S121 to S128 in FIG. 23 are the same as the processes at steps S61 to S68 in FIG. 11. In the example in FIG. 23, if the result at step S128 is in the negative (step S128: No), the multifunction peripheral start-up unit 20 checks the NVRAM 130 (step S133) and checks to see whether an abnormal start-up bit is set or not (step S134). If the result at step S134 is in the negative (step S134: No), because this is an unexpected start-up for the first time, the multifunction peripheral start-up unit 20 sets an abnormal start-up bit in the NVRAM 130 (step S138). The processes at steps S139 to S141 that follow are the same as the processes at steps S72 to S74 in FIG. 11.

On the contrary, if the result at step S134 described above is in the affirmative (step S134: Yes), because this is an unexpected start-up for the second or more time, the multifunction peripheral start-up unit 20 first clears the button pressing notification signal and the WOL notification signal so as to return the state to the initial state (step S135). Subsequently, the multifunction peripheral start-up unit 20 reads the setting file (step S136) and starts up the applications in an abnormal stop mode (step S137). In that situation, the shutdown process is performed.

In another situation, if the result at step S128 described above is in the affirmative (step S128: Yes), the multifunction peripheral start-up unit 20 clears the abnormal start-up bit (step S129). As a result, the abnormal start-up bit is always cleared when a normal start-up is performed. The processes at steps S130 to S132 are the same as the processes at steps S69 to S71 in FIG. 11.

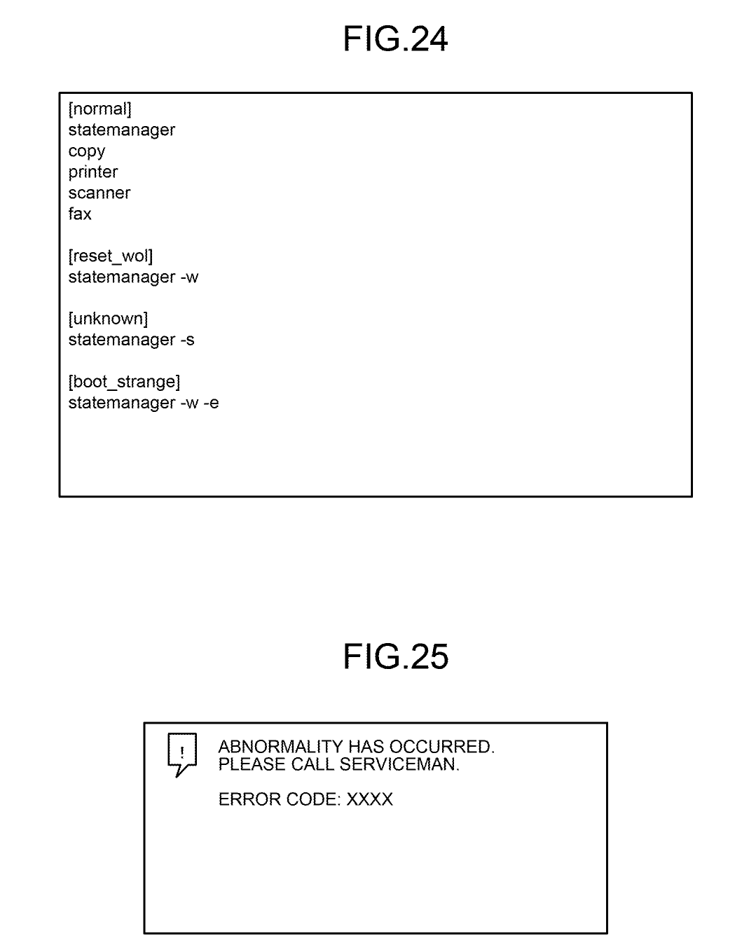

FIG. 24 is a drawing of an example of a setting file according to the present embodiment. In the present example, processes in the normal start-up mode are performed according to what is written in the normal label; processes in the WOL resetting mode are performed according to what is written in the reset wol label; processes in the instant shutdown mode are performed according to what is written in the unknown label (i.e., a state that is not known); and processes in the abnormal stop mode are performed according to what is written in a boot strange label. The abnormal stop mode is different from the instant shutdown mode in that “statemanager” is started up with an “-e option”. In this situation, “statemanager” corresponds to the state management module 30 and, with the “-e option”, causes the LCD 210 to indicate an abnormal stop and stops the system. FIG. 25 is a drawing of an example of the display indicating the abnormal stop.

### Fifth Embodiment

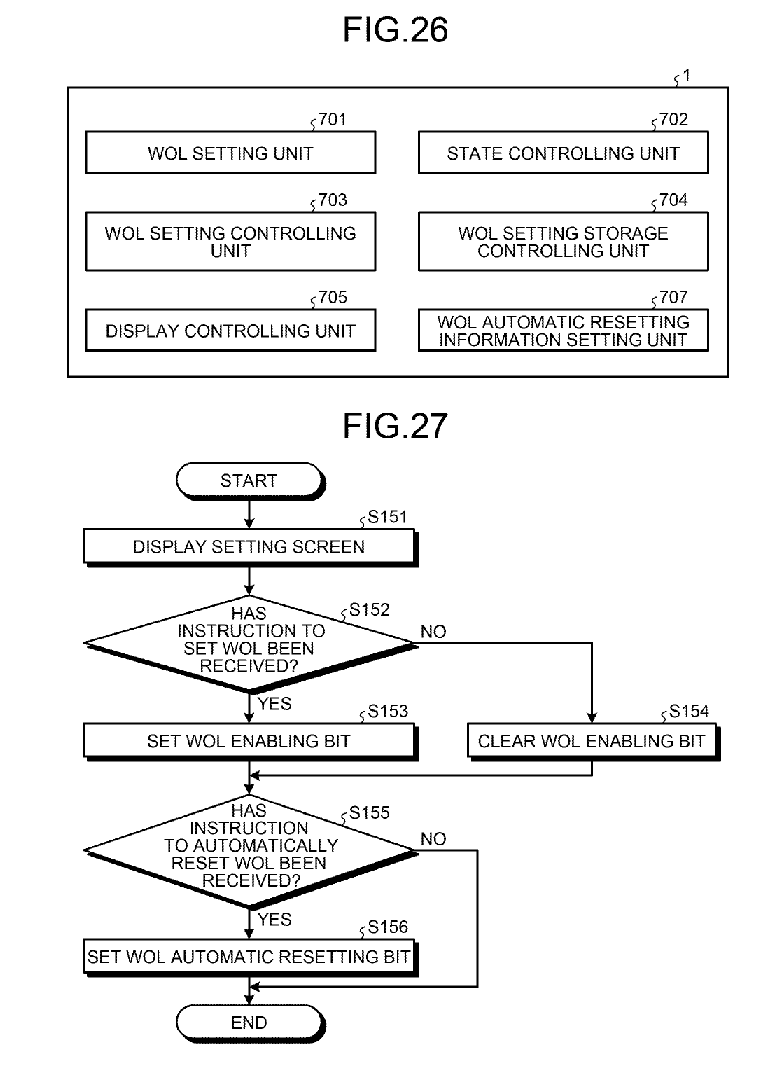

Next, a fifth embodiment will be explained. Explanation of some of the features that are the same as those in the first embodiment above will be omitted. FIG. 26 is a diagram of examples of functions of the multifunction peripheral 1 according to the present embodiment. As illustrated in FIG. 26, the multifunction peripheral 1 further includes a WOL automatic resetting information setting unit 707. In response to an operation by the operator, the WOL automatic resetting information setting unit 707 sets WOL automatic resetting information (called a “WOL automatic resetting bit” in the present example) indicating that the WOL setting enabling information (the WOL enabling bit in the present example) shall be maintained (more specifically, maintained in the internal FRAM 504 in the low-power device microcomputer 500 to which the power continues to be supplied) even after a shutdown. In the present example in the present embodiment, the functions of the WOL automatic resetting information setting unit 707 are provided by the state management module 30. However, possible embodiments are not limited to this example. Upon receiving a shutdown request, if the WOL automatic resetting bit is not set, the state controlling unit 702 exercises control so as not to store the WOL enabling bit in the non-volatile memory (the internal FRAM 504 in the present example).

FIG. 27 is a flowchart of an exemplary operation performed by the multifunction peripheral 1 when establishing various types of settings in response to operations by a user. The processes at steps S151 to S154 in FIG. 27 are the same as the processes at steps S1 to S4 in FIG. 5. When an instruction is received at step S155 indicating that WOL should automatically be reset (step S155: Yes), the WOL automatic resetting information setting unit 707 sets a WOL automatic resetting bit in the NVRAM 130 (step S156). On the contrary, when no instruction indicating that WOL should automatically be set is received (step S155: No), the WOL automatic resetting information setting unit 707 does not set the WOL automatic resetting bit in the NVRAM 130 (or may clear the WOL automatic resetting bit), and the process ends.

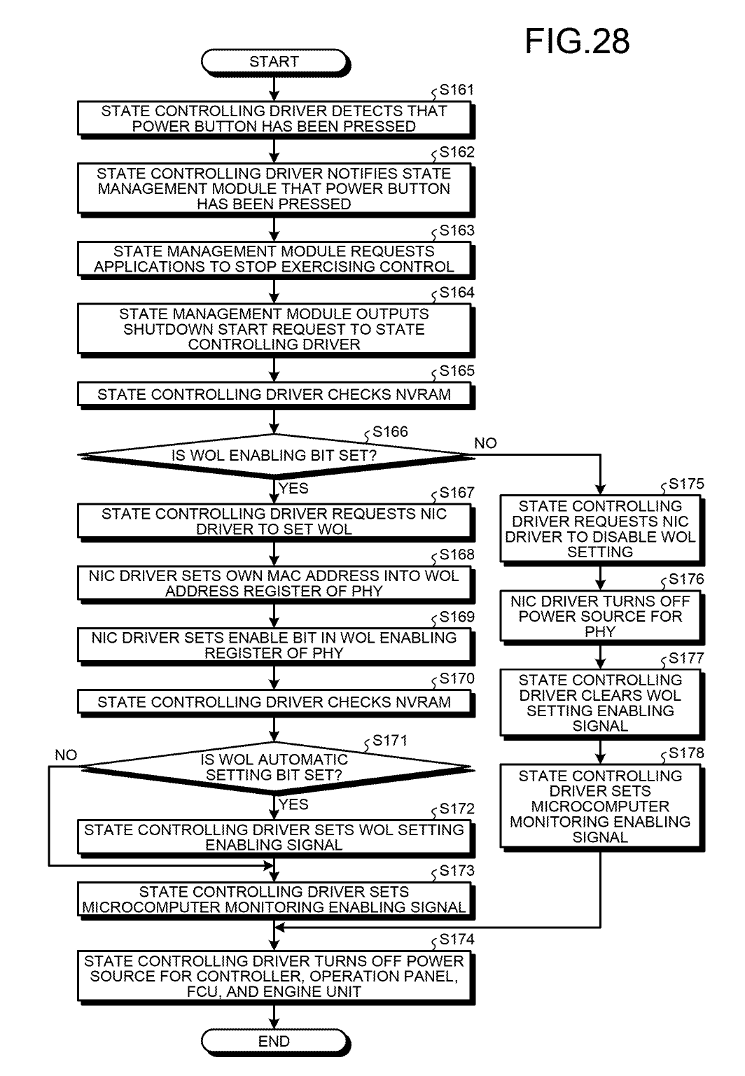

FIG. 28 is a flowchart of an exemplary operation performed by the multifunction peripheral 1 when shutting down. The processes at steps S161 to S169 are the same as the processes at steps S11 to S19 in FIG. 6. After step S169, the state controlling driver 14 checks the NVRAM 130 (step S170). If the WOL automatic resetting bit described above is set in the NVRAM 130 (step S171: Yes), the state controlling driver 14 sets a WOL setting enabling signal (step S172). The process at step S172 is the same as the process at step S20 in FIG. 6. On the contrary, when the WOL automatic resetting bit described above is not set in the NVRAM 130 (step S171: No), the state controlling driver 14 skips the process at step S172 described above and sets a microcomputer monitoring enabling signal (step S173). In other words, before triggering (i.e., without triggering) and requesting the low-power device microcomputer 500 to set a WOL enabling bit in the internal FRAM 504, the microcomputer monitoring enabling signal is set. As a result, during the operation of the low-power device microcomputer 500 that is performed when the power supply from the external power source to the low-power device microcomputer 500 is started upon connecting the power plug 620 or upon recovery from a power outage, the result at step S53 in FIG. 10 is always in the negative. Consequently, the power source will never automatically be turned on (without receiving the pressing of the power button).

In this situation, the processes at steps S174 to S178 are the same as the processes at steps S22 to S26 in FIG. 6.

### Sixth Embodiment

Next, a sixth embodiment will be explained. Explanation of some of the features that are the same as those in the first embodiment above will be omitted. In the present embodiment, while the multifunction peripheral 1 is in in the WOL standby state, if the time period during which the power button is pressed, which serves as a trigger for starting the power supply from the external power source, is equal to or longer than a threshold, the low-power device microcomputer 500 exercises control so as to erase the WOL enabling bit from the non-volatile memory (the internal FRAM 504 in the low-power device microcomputer 500 in the present example).

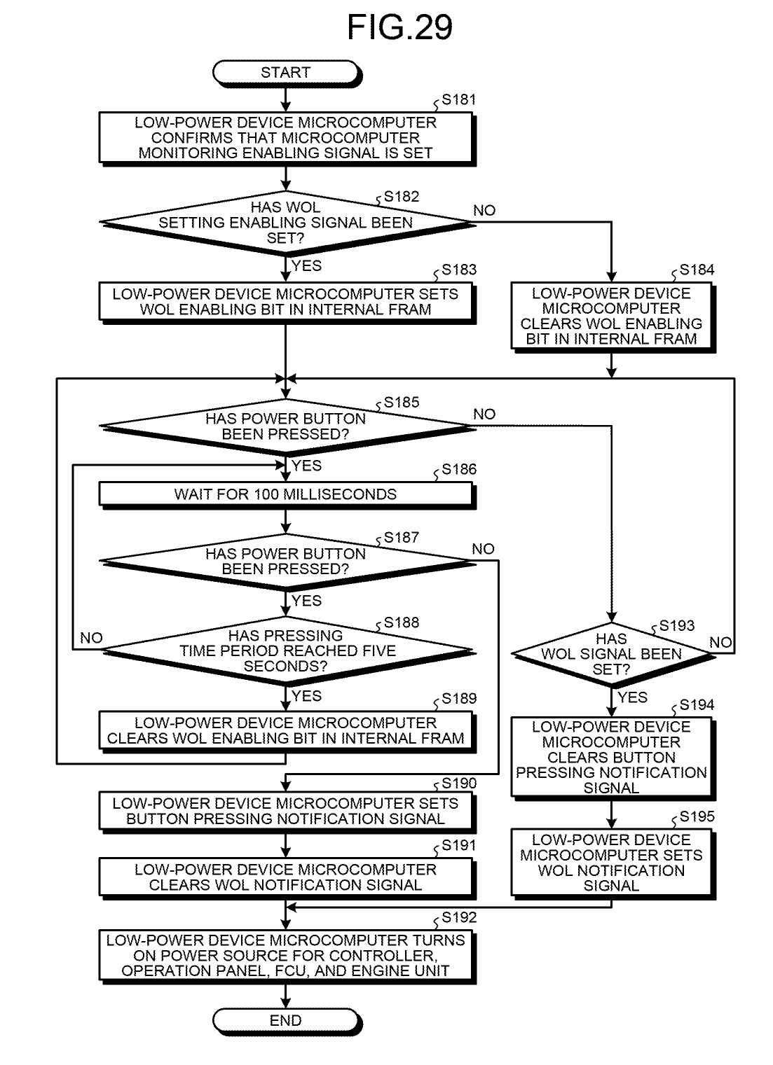

FIG. 29 is a flowchart of an exemplary operation performed by the low-power device microcomputer 500 according to the present embodiment after a shutdown. The processes at steps S181 to S185 are the same as the processes at steps S31 to S35 in FIG. 9. If the result at step S185 is in the affirmative (step S185: Yes), after a waiting period of 100 milliseconds [ms] has elapsed (step S186), the low-power device microcomputer 500 checks to see whether or not the power button 610 has been pressed (step S187). If the result at step S187 is in the affirmative (step S187: Yes), the low-power device microcomputer 500 checks to see whether or not the pressing time period (the time period during which the operation of pressing the power button 610 is continued) has reached five seconds (which is an example of the “threshold”, but a possible threshold value is not limited to this example) (step S188). On the contrary, if the result at step S187 is in the negative (step S187: No), the low-power device microcomputer 500 determines that the pressing was not a long press (determines that the pressing was a normal pressing operation on the power button 610). Consequently, the process proceeds to step S190.

If the result at step S188 is in the affirmative (step S188: Yes), the low-power device microcomputer 500 clears the WOL enabling bit in the internal FRAM 504 (step S189), and the process returns to step S185. If the result at step S188 is in the negative (step S188: No), the process proceeds to step S186.

The processes at steps S190 to S195 in FIG. 29 are the same as the processes at steps S36 to S41 in FIG. 9.

The computer program executed by the multifunction peripheral 1 according to any of the embodiments described above may be configured to be provided as being recorded on a computer-readable recording medium such as a Compact Disk Read-Only Memory (CD-ROM), a Flexible Disk (FD), a Compact Disk Recordable (CD-R), a Digital Versatile Disk (DVD), or a Universal Serial Bus (USB), in a file in an installable format or an executable format or may be configured to be provided or distributed via a network such as the Internet. Further, various types of computer programs may be configured to be provided as being incorporated in a Read-Only Memory (ROM) or the like, in advance.

According to an embodiment, even if the external power is cut off while WOL is set, it is possible to perform return to the state where it is possible to turn on the power source by using WOL.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus comprising:
an information processing unit that performs information processing;
a power controlling unit that is connected to an external power source and exercises power control;
a Wake_on_LAN (WOL) setting unit that sets WOL setting set information indicating whether a WOL is set or not, the WOL being a function by which power supply to at least the information processing unit is started when being triggered by receipt of a specific packet from a server;
a state controlling unit that when receiving a shutdown start request requesting that the power supply to at least the information processing unit be stopped while power supply to at least the power controlling unit be continued and if the WOL setting set information indicates that the WOL is set, exercises control so as to transition into a WOL standby state in which the power supply to at least the information processing unit is stopped, while power supply to a receiving unit that receives the specific packet and to the power controlling unit is continued;
a WOL setting controlling unit that exercises control so as to set the WOL before transition into the WOL standby state; and
a WOL setting storage controlling unit that, upon transition into the WOL standby state, exercises control so as to store WOL setting enabling information indicating that the WOL has been set, into a non-volatile memory.

2. The information processing apparatus according to claim 1, wherein, when the power supply from the external power source to the power controlling unit is started, while the WOL setting enabling information is stored in the non-volatile memory, the power controlling unit starts the power supply to at least the information processing unit, and the WOL setting controlling unit exercises control so as to set the WOL.

3. The information processing apparatus according to claim 2, wherein after the WOL setting controlling unit exercises control so as to set the WOL, the state controlling unit exercises control so as to cause the information processing apparatus to transition into the WOL standby state.

4. The information processing apparatus according to claim 2, wherein the WOL setting controlling unit exercises control so as to, at least, set a MAC address indicating a physical address uniquely assigned to the information processing apparatus, into the receiving unit.

5. The information processing apparatus according to claim 4, wherein the specific packet contains at least the MAC address indicating the physical address uniquely assigned to the information processing apparatus.

6. The information processing apparatus according to claim 2, further comprising: a display controlling unit that, when the WOL setting controlling unit exercises control so as to set the WOL, exercises control so as to cause a display unit to display that the WOL is currently set.

7. The information processing apparatus according to claim 2, wherein, when the power supply from the external power source is started while the WOL setting enabling information is stored in the non-volatile memory, the power controlling unit does not supply power to a display unit that displays an information processing result of the information processing unit.

8. The information processing apparatus according to claim 2, further comprising: an expansion processing unit that performs information processing in an expanded manner, wherein
when the power supply from the external power source is started while the WOL setting enabling information is stored in the non-volatile memory, the power controlling unit does not supply power to the expansion processing unit.

9. The information processing apparatus according to claim 6, wherein, when the power supply from the external power source is started without issuance of a signal that triggers the power supply to start while the WOL setting enabling information is not set, the display controlling unit exercises control so as to cause the display unit to display that the information processing apparatus is to shut down.

10. The information processing apparatus according to claim 9, further comprising: an abnormal start-up information setting unit that, when the power supply from the external power source is started without issuance of a signal that triggers the power supply to start while the WOL setting enabling information is not set, checks to see whether abnormal start-up information indicating an abnormal start-up has already been set or not and, if the abnormal start-up information has not yet been set, exercises control so as to set the abnormal start-up information.

11. The information processing apparatus according to claim 10, wherein, when the abnormal start-up information setting unit exercises control so as to set the abnormal start-up information, the display controlling unit exercises control so as to cause the display unit to display that the information processing apparatus is to shut down.

12. The information processing apparatus according to claim 10, wherein when the abnormal start-up information setting unit does not exercise control so as to set the abnormal start-up information, but the abnormal start-up information has already been set, the display controlling unit exercises control so as to cause the display unit to display that the information processing apparatus is in an abnormal state.

13. The information processing apparatus according to claim 1, further comprising: a WOL automatic resetting information setting unit that, in response to an operation performed by a user, sets WOL automatic resetting information indicating that the WOL setting enabling information shall be maintained even after a shutdown, wherein
upon receiving the shutdown request, if the WOL automatic resetting information is not set, the state controlling unit exercises control so as not to store the WOL setting enabling information into the non-volatile memory.

14. The information processing apparatus according to claim 1, wherein, in the WOL standby state, if a pressing time period on a power button used as a trigger for starting the power supply from the external power source is equal to or longer than a threshold, the power controlling unit exercises control so as to erase the WOL setting enabling information from the non-volatile memory.

15. An information processing method implemented by an information processing apparatus including at least an information processing unit that performs information processing and a power controlling unit that is connected to an external power source and exercises power control, the information processing method comprising:
setting WOL setting set information indicating whether a WOL is set or not, the WOL being a function by which power supply to at least the information processing unit is started when being triggered by receipt of a specific packet from a server;
when receiving a shutdown start request requesting that the power supply to at least the information processing unit be stopped while power supply to at least the power controlling unit be continued and if the WOL setting set information indicates that the WOL is set, exercising control so as to transition into a WOL standby state in which the power supply to at least the information processing unit is stopped, while power supply to a receiving unit that receives the specific packet and to the power controlling unit is continued;
exercising control so as to set the WOL before transition into the WOL standby state; and
upon transition into the WOL standby state, exercising control so as to store WOL setting enabling information indicating that a setting of the WOL is enabled, into a non-volatile memory included in the power controlling unit.

16. A computer program product comprising a non-transitory computer-readable medium containing an information processing program for a computer of an information processing apparatus including at least an information processing unit that performs information processing and a power controlling unit that is connected to an external power source and exercises power control, the program causing the computer to perform:
setting WOL setting set information indicating whether a WOL is set or not, the WOL being a function by which power supply to at least the information processing unit is started when being triggered by receipt of a specific packet from a server;
when receiving a shutdown start request requesting that the power supply to at least the information processing unit be stopped while power supply to at least the power controlling unit be continued and if the WOL setting set information indicates that the WOL is set, exercising control so as to transition into a WOL standby state in which the power supply to at least the information processing unit is stopped, while power supply to a receiving unit that receives the specific packet and to the power controlling unit is continued;
exercising control so as to set the WOL before transition into the WOL standby state; and
upon transition into the WOL standby state, exercising control so as to store WOL setting enabling information indicating that a setting of the WOL is enabled, into a non-volatile memory included in the power controlling unit.
